(19) United States
(12) Patent Application Publication
(10) Pub. No.: US 2025/0138809 A1
(43) Pub. Date: May 1, 2025

(54) TERMINAL DEVICE, INFORMATION PROCESSING SYSTEM, AND APPLICATION UPDATING METHOD

(71) Applicant: CANON KABUSHIKI KAISHA, Tokyo (JP)

(72) Inventor: KENJI KASUYA, Kanagawa (JP)

(21) Appl. No.: 18/932,164

(22) Filed: Oct. 30, 2024

(30) Foreign Application Priority Data
Nov. 1, 2023 (JP) 2023-187632

(51) Int. Cl. G06F 8/65

(52) U.S. Cl. CPC G06F 8/65

(57) ABSTRACT

A terminal device connectable to an information processing apparatus includes a setting unit configured to allow performing a setting as to whether to individually perform automatic updating with respect to each piece of application software which runs in the information processing apparatus.

### BACKGROUND

### Field

Aspects of the present disclosure generally relate to a terminal device, an information processing system, an application updating method, and an application updating storage medium.

### Description of the Related Art

Heretofore, there has been known a technique which, for function enhancement, performs additional downloading and installation of application software (hereinafter referred to as an “application”) on an information processing apparatus such as an image forming apparatus or an image reading apparatus.

For example, Japanese Patent Application Laid-Open No. 2018-198013 discusses a technique in which an information processing apparatus performs direct communication with an application distribution server and acquires information about applications for an image forming apparatus and the image forming apparatus installs a new application thereon. Moreover, in the technique, the image forming apparatus updates a previously installed application.

In this way, even with regard to applications which run in the same information processing apparatus, the applications have respective different situations or properties (hereinafter referred to as “application properties”). Accordingly, it is desirable that the user refer to the application properties and set the respective automatic updatings of the applications, thus avoiding various troubles caused by such updating.

However, in the technique discussed in Japanese Patent Application Laid-Open No. 2018-198013, the user is not allowed to individually set the respective automatic updatings of the applications, and, therefore, if the user collectively turns on the automatic updatings in disregard of the above-mentioned application properties, the probability of occurrence of various troubles caused by the above-mentioned application properties becomes high. Conversely, if the user collectively turns off the automatic updatings, the user is to perform a cumbersome operation for an operation to permit each updating with respect to an application which causes no problem even if being automatically updated.

### SUMMARY OF THE INVENTION

According to an aspect of the present disclosure, a terminal device connectable to an information processing apparatus includes a setting unit configured to allow performing a setting as to whether to individually perform automatic updating with respect to each piece of application software which runs in the information processing apparatus.

Further features of the present disclosure will become apparent from the following description of exemplary embodiments with reference to the attached drawings.

### BRIEF DESCRIPTION OF THE DRAWINGS

FIG. 1 is a block diagram illustrating a network configuration in an exemplary embodiment of the present disclosure.

FIG. 2 is a block diagram illustrating a hardware configuration of an image forming apparatus.

FIG. 3 is a schematic diagram illustrating an operation unit of the image forming apparatus.

FIG. 4 is a block diagram illustrating a software configuration of the image forming apparatus.

FIG. 5 is a block diagram illustrating a hardware configuration of a mobile terminal.

FIG. 6 is a block diagram illustrating a software configuration of the mobile terminal.

FIGS. 7A, 7B, 7C, 7D, 7E, and 7F are schematic diagrams illustrating display examples of screens of the mobile terminal.

FIG. 8 is a sequence diagram illustrating operations which are performed to install an application on the mobile terminal.

FIG. 9 is a block diagram illustrating a software configuration of a multifunction peripheral (MFP) utility.

FIG. 10A is a diagram illustrating a data structure of basic information about the MFP utility. FIG. 10B is a diagram illustrating a data structure of additional application information.

FIG. 11 is a sequence diagram illustrating operations which are performed to register a cooperation device with the MFP utility.

FIGS. 12A, 12B, 12C, and 12D are schematic diagrams illustrating display examples of a home screen and device registration screens of the MFP utility.

FIG. 13 is a sequence diagram illustrating operations which are performed to install an additional application on the image forming apparatus.

FIGS. 14A, 14B, 14C, 14D, and 14E are schematic diagrams illustrating display examples of screens of the MFP utility which are displayed to install the additional application on the image forming apparatus.

FIGS. 15A and 15B are schematic diagrams illustrating examples of additional application detail screens which the MFP utility provides.

FIG. 16 is a sequence diagram illustrating operations which are performed to automatically update an additional application for the image forming apparatus.

FIGS. 17A and 17B are schematic views illustrating display examples of screens of the MFP utility which are displayed to automatically update an additional application for the image forming apparatus.

FIGS. 18A and 18B are flowcharts used to explain automatic updating processing concerning an additional application for the image forming apparatus, which is performed by the MFP utility.

FIG. 19 is a flowchart used to explain additional application update processing, which is performed by the image forming apparatus.

FIG. 20 is a schematic diagram illustrating a display example of an additional application updating-in-progress screen which is displayed by the image forming apparatus.

FIG. 21A is a diagram illustrating a data structure of basic information about the MFP utility. FIG. 21B is a diagram illustrating a data structure of additional application information.

FIG. 22 is a flowchart used to explain processing which is performed by the MFP utility to change automatic updating setting concerning an additional application for the image forming apparatus.

FIGS. 23A and 23B are schematic diagrams illustrating examples of additional application detail screens which the MFP utility provides.

FIG. 24 is a diagram illustrating, with use of related blocks of the MFP utility, flows which are executed to perform automatic updating setting for individual additional applications for the image forming apparatus.

### DESCRIPTION OF THE EMBODIMENTS

Various exemplary embodiments, features, and aspects of the disclosure will be described in detail below with reference to the drawings, and, however, the exemplary embodiments are not intended to limit the disclosure set forth in claims, and not all of the combinations of features described in the exemplary embodiments are not necessarily essential for solutions in the disclosure.

A first exemplary embodiment of the present disclosure is described.

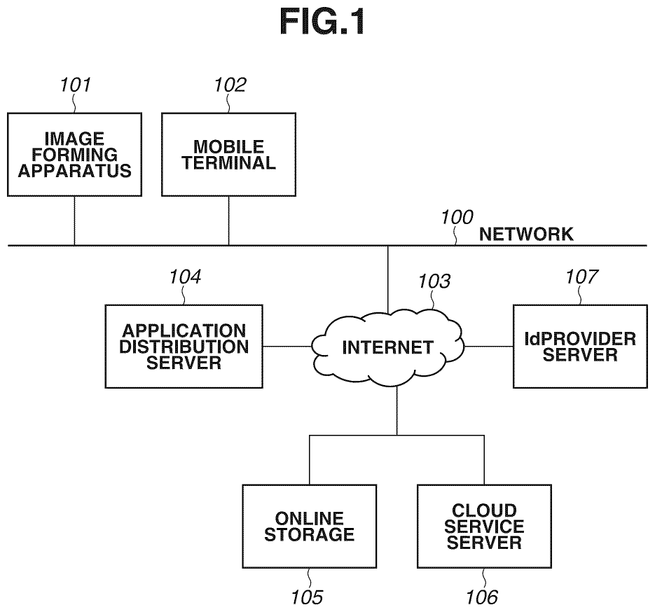

FIG. 1 is a block diagram illustrating a network configuration in the first exemplary embodiment.

An image forming apparatus 101 is a multifunction peripheral (MFP), and a mobile terminal 102 is a terminal device which includes, for example, a communication function using mobile communication, a network connection function using wireless communication, a web browser function, and a camera function. Moreover, a network 100 is a communication network which is connectable to the Internet 103.

Furthermore, the image forming apparatus 101 is configured to connect to the network 100 with wired connection and the mobile terminal 102 is configured to connect to the network 100 with wireless connection via an access point (not illustrated) of the network 100, so that the image forming apparatus 101 and the mobile terminal 102 perform communication with each other. Furthermore, these communication connection methods are not limited to wired and wireless connections, but can be any methods as long as those are available for communication.

The Internet 103 is a publicly known and publicly used Internet communication network, to which an application distribution server 104, which provides a web service, an online storage 105, a cloud service server 106, and an IdProvider server 107 are connected.

The application distribution server 104 connects to the mobile terminal 102 via the Internet 103 and the network 100, thus performing authentication on the mobile terminal 102. Here, in a case where a user account is currently registered in the mobile terminal 102, the mobile terminal 102 displays a catalog of applications which are currently installed on the image forming apparatus 101.

As a result, in response to the user individually selecting each application from the catalog, the mobile terminal 102 is able to individually download and install each application from the application distribution server 104.

The online storage 105 stores various pieces of data including image files.

The cloud service server 106 receives image data obtained by the image forming apparatus 101 performing scanning, and, for example, performs predetermined processing on the image data after extracting text information included in the image data by optical character recognition (OCR) processing.

Moreover, the cloud service server 106 provides a service which, in response to a request from the image forming apparatus 101, transmits, as a response, image data to the image forming apparatus 101 and causes the image forming apparatus 101 to perform print outputting of the image data. The IdProvider server 107 is a server which performs authentication for the image forming apparatus 101 and the mobile terminal 102 to access the application distribution server 104, the online storage 105, and the cloud service server 106.

Specifically, the image forming apparatus 101 or the mobile terminal 102 accesses the application distribution server 104, the online storage 105, and the cloud service server 106. Then, the image forming apparatus 101 or the mobile terminal 102 is redirected to the IdProvider server 107 and then performs login processing, thus acquiring authentication information. The image forming apparatus 101 or the mobile terminal 102 uses the acquired authentication information to access the application distribution server 104, the online storage 105, and the cloud service server 106, thus becoming able to use the service.

Furthermore, the application distribution server 104, the online storage 105, the cloud service server 106, and the IdProvider server 107 are operated from the outside of each server via communication interfaces (I/Fs). Furthermore, each of these servers includes, for example, a central processing unit (CPU), a random access memory (RAM), a read-only memory (ROM), and a communication I/F (each not illustrated).

Moreover, the image forming apparatus 101, the mobile terminal 102, the application distribution server 104, the online storage 105, the cloud service server 106, and the IdProvider server 107 are able to communicate with each other via the Internet 103.

The image forming apparatus 101 transmits image data obtained by reading an original to the mobile terminal 102, the online storage 105, or the cloud service server 106. Moreover, the mobile terminal 102 is able to install and then execute an application for the image forming apparatus 101 downloaded from the application distribution server 104. Furthermore, the application includes, for example, a function which transmits an image read by the image forming apparatus 101 to the online storage 105 and a function which acquires an image stored in the online storage 105, transmits the acquired image to the image forming apparatus 101, and causes the image forming apparatus 101 to perform printing of the image.

Moreover, the mobile terminal 102 acquires the status of the image forming apparatus 101 using HyperText Transfer Protocol (HTTP) and displays the acquired status. Moreover, the mobile terminal 102 is also used for use applications which change the various settings of the image forming apparatus 101, transmit data stored in the mobile terminal 102 to the image forming apparatus 101 to cause the image forming apparatus 101 to perform printing of the data, and acquire an image read by the image forming apparatus 101.

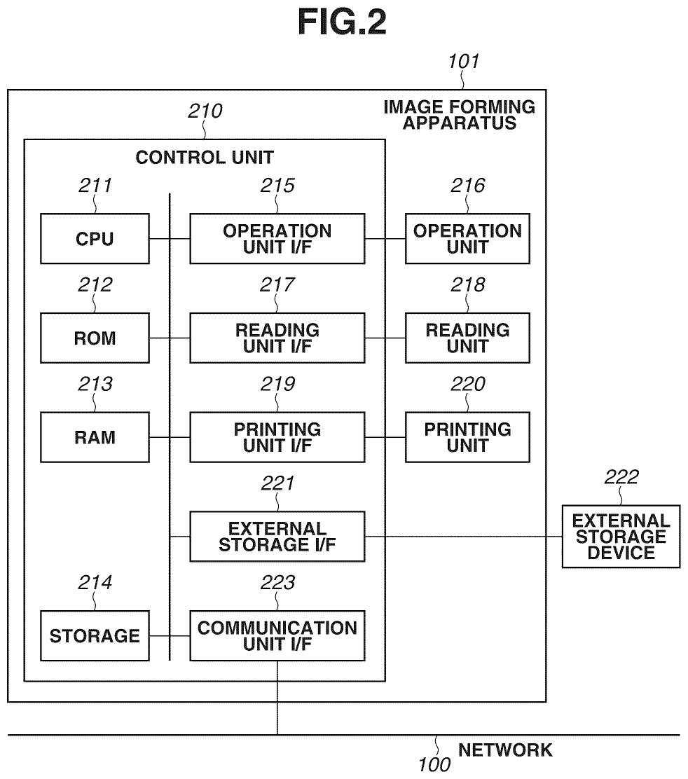

FIG. 2 is a block diagram illustrating a hardware configuration of the image forming apparatus 101.

The image forming apparatus 101 includes a control unit 210, an operation unit 216, a reading unit 218, and a printing unit 220.

The control unit 210 includes a CPU 211, a ROM 212, a RAM 213, a storage 214, an operation unit interface (I/F) 215, a reading unit I/F 217, a printing unit I/F 219, an external storage I/F 221, and a communication unit I/F 223.

CPU is an abbreviation for central processing unit. ROM is an abbreviation for read-only memory. RAM is an abbreviation for random access memory.

The CPU 211 controls operations of the image forming apparatus 101. The CPU 211 reads out a program stored in the ROM 212 or the storage 214 onto the RAM 213 and executes the program.

Here, the program is, for example, a control program, and the CPU 211 performs various control operations such as reading control and printing control by executing the control program.

The ROM 212 stores programs which are to be executed by the CPU 211. Moreover, the ROM 212 also stores, for example, a boot program and font data. The RAM 213 is a main storage memory for the CPU 211. The RAM 213 is used as a work area for the CPU 211 and a temporary storage region used to load programs stored in the ROM 212 and the storage 214 thereon. Moreover, the RAM 213 is also used to temporarily store image data.

The storage 214 stores image data, print data, an address book, shortcuts, various programs, and various pieces of setting information. In the first exemplary embodiment, the storage 214 is assumed to be a flash memory, but an auxiliary storage device such as an SSD, an HDD, or an eMMC can also be used therefor. SSD is an abbreviation for solid state drive. HDD is an abbreviation for hard disk drive. eMMC is an abbreviation for embedded multi media card.

The operation unit I/F 215 connects an operation unit 216 and the control unit 210 to each other. The operation unit 216 includes hardware keys and a touch panel. The touch panel is configured with a touch panel sheet being affixed to a display. The operation unit 216 receives an operation performed by the user with the hardware keys and displays a screen via the touch panel.

The reading unit I/F 217 connects a reading unit 218 and the control unit 210 to each other. The reading unit 218 reads an original and then generates image data. The image data generated by the reading unit 218 is transmitted to an external apparatus or is printed on a sheet for printing.

The printing unit I/F 219 connects a printing unit 220 and the control unit 210 to each other. The CPU 211 transfers image data to be printed (image data targeted for printing) to the printing unit 220 via the printing unit I/F 219. The printing unit 220 prints an image on a sheet fed from a feeding cassette (not illustrated). The method of printing an image can be any one of an electrophotographic method, which prints an image using toner, and an inkjet method, which prints an image using ink.

The external storage I/F 221 connects an external storage device 222 and the control unit 210 to each other. The CPU 211 stores image data in the external storage device 222 via the external storage I/F 221. In the first exemplary embodiment, the external storage I/F 221 is assumed to be a Universal Serial Bus (USB) interface, and the external storage device 222 is assumed to be a USB memory. However, for example, a Secure Digital Card (SD card) can also be used for the external storage device 222.

The control unit 210 is connected to the network 100 by the communication unit I/F 223. The network 100 is, for example, a LAN. LAN is an abbreviation for local area network.

The communication unit I/F 223 controls transmission and reception of data which are performed via the network 100. For example, the image forming apparatus 101 transmits and receives various pieces of setting information for the inside of the image forming apparatus 101 between the mobile terminal 102 and the image forming apparatus 101 via the communication unit I/F 223, and transmits image data to the online storage 105.

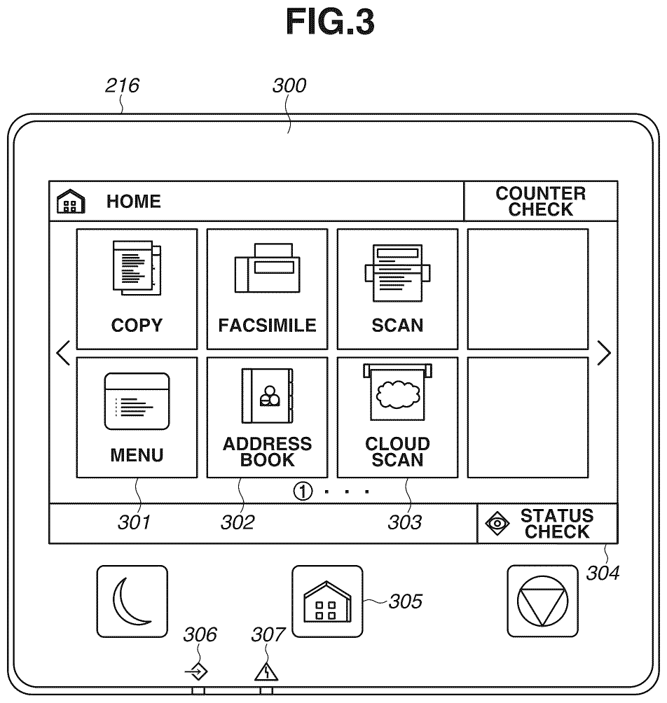

FIG. 3 is a diagram illustrating the operation unit 216 of the image forming apparatus 101.

The operation unit 216 is configured with a touch panel 300, a data light-emitting diode (LED) 306, and an error LED 307.

The touch panel 300 illustrated in FIG. 3 shows a home screen, which is displayed immediately after the image forming apparatus 101 is started up. Furthermore, the home screen is a screen which is used to give an instruction to perform each function of the image forming apparatus 101. For example, the home screen displays a copy button, which is operated to use a copy function for causing the printing unit 220 to perform printing of an image that is based on image data generated by the reading unit 218 reading an original. Moreover, the home screen displays a facsimile button, which is operated to use a facsimile function for causing a modem (not illustrated) to transmit image data generated by the reading unit 218 reading an original. Moreover, the home screen displays a scan button, which is operated to use a transmission function for transmitting, via the communication unit I/F 223, image data generated by the reading unit 218 reading an original.

Furthermore, the above-mentioned transmission function includes, for example, an e-mail function for transmitting image data while attaching the image data to an e-mail and a folder transmission function for transmitting image data to store the image data in a designated folder. Additionally, the home screen displays a menu button 301, an address book button 302 for calling up an address book and displays the address book, and a cloud scan button 303 for performing image transmission to the online storage 105. A status check button 304 is a button for displaying and checking an operation status of the image forming apparatus 101 or an execution history of each type of job.

A home key 305, which is an electrostatic touch key, is a button for switching a screen which is currently displayed to the home screen.

The data LED 306 is turned on in the process of transmission of data, thus notifying the user that the image forming apparatus 101 is transmitting data.

The error LED 307 is turned on when some error has occurred in the image forming apparatus 101.

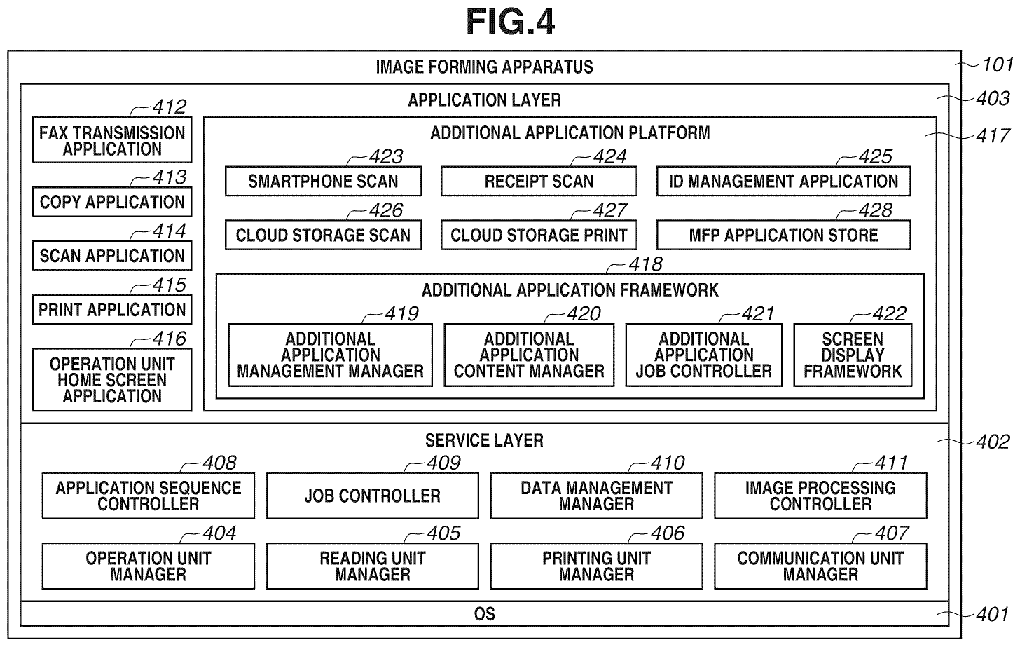

FIG. 4 is a diagram illustrating a software configuration of the image forming apparatus 101. While, for explanatory convenience, in FIG. 4, functions for the first exemplary embodiment are mainly illustrated, the functions included in the image forming apparatus 101 are not limited to the illustrated functions.

Software of the image forming apparatus 101 is configured with an operating system (OS) 401, a service layer 402, and an application layer 403, and the CPU 211 executes these pieces of software.

The OS 401 is basic software of the image forming apparatus 101. Each piece of software on the image forming apparatus 101 runs as a process or thread on the OS 401.

The service layer 402 is a software module group which has a function to control, for example, various hardware resources and causes, for example, applications of the application layer 403, which is higher order than the service layer 402, to use the function. The software module group includes, for example, an operation unit manager 404, which provides a function related to the operation unit 216, and a reading unit manager 405, which provides a control function for the reading unit 218. Moreover, the software module group includes a printing unit manager 406, which provides a control operation for the printing unit 220, and a communication unit manager 407, which provides functions related to wired LAN, wireless LAN, and short-range wireless communication. Additionally, the software module group includes, for example, a data management manager 410, which performs data administration for the ROM 212, the RAM 213, the storage 214, and the external storage device 222, and an image processing controller 411, which performs, for example, image processing and format conversion. Moreover, the software module group includes an application sequence controller 408, which performs sequence management of jobs in which applications of the application layer 403 are run, and a job controller 409, which performs, for example, management of a competitive operation between a job and a job in which the applications are run.

The application layer 403 is a basic application group, which runs on the service layer 402, and the basic application group includes, as applications, for example, a facsimile (FAX) transmission application 412, a copy application 413, a scan application 414, a print application 415, and an operation unit home screen application 416.

Then, the basic application group also includes an additional application platform 417 which is used to additionally install an application from the outside different from the image forming apparatus 101 and then execute the installed application.

The basic applications implement their functions with direct use of interfaces of the service layer 402. For example, when the operation unit home screen application 416 activates the copy application 413, the operation unit manager 404 is used to cause the touch panel 300 to display a copy setting screen. Upon receiving a job start instruction after setting is performed at the copy setting screen, the operation unit manager 404 notifies the copy application 413 of the setting information.

The copy application 413 performs allocation of the RAM 213 from the data management manager 410 according to the setting information. Then, the copy application 413 notifies the reading unit manager 405 of setting information such as resolution, size, color information, and the allocated region of the RAM 213, and notifies the printing unit manager 406 of setting information such as the number of copies, resolution, color information, and the allocated region of the RAM 213. Moreover, the copy application 413 notifies the application sequence controller 408 and the job controller 409 of operation sequences of the reading unit manager 405 and the printing unit manager 406, thus determining the operation timing.

The reading unit manager 405 stores image data acquired from the reading unit 218 according to the setting information in the allocated region of the RAM 213 serving as a storage location, and the printing unit manager 406 acquires image data stored in the RAM 213, sends the acquired image data to the printing unit 220, and thus causes the printing unit 220 to perform printing of the image data.

When printing is completed, the printing unit manager 406 notifies the job controller 409 of the completion of printing, and, upon confirming the completion of the job, the job controller 409 activates the operation unit home screen application 416 and then returns to the idle state.

The additional application platform 417 includes an additional application framework 418, which is used to execute an additional application.

The additional application framework 418 includes an additional application management manager 419, an additional application content manager 420, an additional application job controller 421, and a screen display framework 422.

The additional application management manager 419 performs management of an application added to the additional application platform 417. The additional application management manager 419 checks an additional application retained in the image forming apparatus 101 at the time of start-up, notifies the operation unit home screen application 416 of the additional application, and requests the operation unit home screen application 416 to perform icon display of the additional application. Moreover, upon receiving a request for addition of an additional application from the communication unit manager 407, the additional application management manager 419 checks the capacity of an application addition region of the data management manager 410.

Then, upon confirming that the capacity is sufficient, the additional application management manager 419 downloads an application, installs the application, and notifies the operation unit manager 404 of an icon of the added application, thus causing the icon to be displayed.

The additional application content manager 420, the additional application job controller 421, and the screen display framework 422 are used to implement the function of an additional application. As an example, the execution of a cloud storage scan 426 is described.

In the operation unit home screen application 416, the user touches an icon for cloud storage scan. Then, the additional application management manager 419 checks, with the additional application content manager 420, application information about cloud storage scan. The additional application content manager 420 checks, based on the application information, whether it is possible to allocate the RAM 213 for loading and scanning of the application.

Upon the completion of allocation of the RAM 213, the additional application management manager 419 loads, on the RAM 213, an application for the cloud storage scan 426 stored in the storage 214. The cloud storage scan 426 corresponding to the loaded application uses the screen display framework 422 to cause the operation unit manager 404 to display a setting screen for the cloud storage scan 426 on the touch panel 300.

Upon receiving a job start instruction after setting is performed at the cloud storage scan setting screen, the operation unit manager 404 notifies the cloud storage scan 426 of the setting information via the screen display framework 422. According to the setting information, the cloud storage scan 426 notifies the reading unit manager 405 of setting information such as resolution, size, color information, and the allocated region of the RAM 213.

Moreover, the cloud storage scan 426 notifies the communication unit manager 407 of setting information such as destination address, path, login information, and the allocated region of the RAM 213. The additional application job controller 421 notifies the application sequence controller 408 and the job controller 409 of operation sequences of the reading unit manager 405 and the communication unit manager 407, thus determining the operation timing.

The reading unit manager 405 stores image data acquired from the reading unit 218 according to the setting information in the allocated region of the RAM 213 serving as a storage location. Then, the communication unit manager 407 acquires image data stored in the RAM 213, sends the acquired image data to the communication unit I/F 223, and thus stores the image data in the online storage 105.

The communication unit I/F 223 connects to the online storage 105 at the address of the set transmission destination, logs in to the online storage 105 with the login information, and then stores the image data in the designated path of the online storage 105. Upon the completion of storage of the image data, the online storage 105 notifies the communication unit I/F 223 of a result of the storage. Then, upon notifying the job controller 409 of the completion of storage, the communication unit I/F 223 executes end processing of the job, notifies the additional application job controller 421 of the ending of the job, activates the operation unit home screen application 416, and then returns to the idle state.

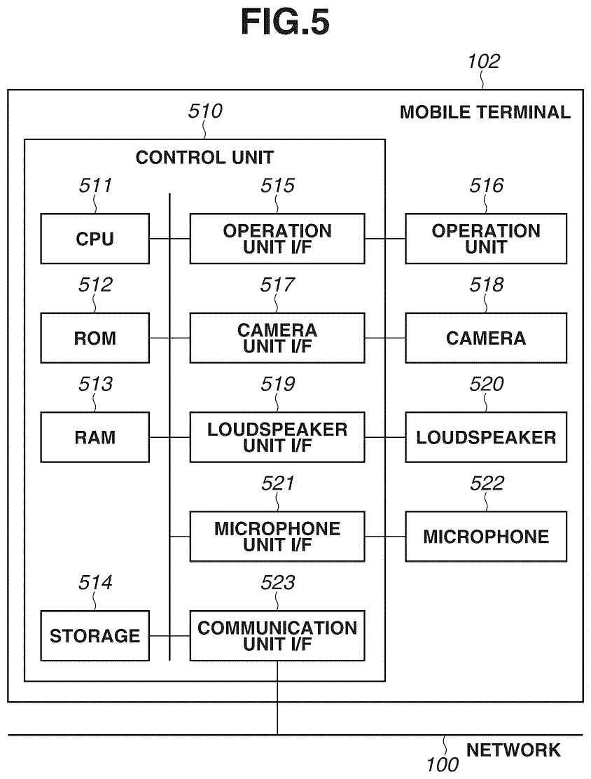

FIG. 5 is a functional block diagram illustrating a hardware configuration of the mobile terminal 102.

The mobile terminal 102 includes a control unit 510, an operation unit 516, a camera 518, a loudspeaker 520, and a microphone 522.

The control unit 510 includes a CPU 511, a ROM 512, a RAM 513, a storage 514, an operation unit I/F 515, a camera unit I/F 517, a loudspeaker unit I/F 519, a microphone unit I/F 521, and a communication unit I/F 523.

The CPU 511 controls the entirety of the mobile terminal 102, and reads out and executes a program stored in the ROM 512 or the storage 514. The program is, for example, a control program, and the CPU 511 performs various control operations such as communication control and camera control by executing the control program.

The ROM 512 stores programs which are to be executed by the CPU 511, and also stores, for example, a boot program and font data.

The RAM 513 is a main storage memory for the CPU 511, and is used as a work area for the CPU 511 and a temporary storage region used to load programs stored in the ROM 512 thereon.

The storage 514 stores, for example, applications, image data, an address book, and music data. In the first exemplary embodiment, the storage 514 is assumed to be a storage device of the flash ROM type such as a Secure Digital (SD) card.

The operation unit I/F 515 connects an operation unit 516 and the control unit 510 to each other, includes hardware keys and a touch panel, receives a user operation, and displays various pieces of information on the screen thereof. The touch panel is configured integrally with a display with transparent electrodes forming the touch panel deposited to the display.

The camera unit I/F 517 connects the camera 518 and the control unit 510 to each other. Moreover, the loudspeaker unit I/F 519 connects the loudspeaker 520 and the control unit 510 to each other. Additionally, the microphone unit I/F 521 connects the microphone 522 and the control unit 510 to each other.

The camera 518, the loudspeaker 520, and the microphone 522 are caused to operate by the control unit 510 according to programs at the time of execution of applications stored in the ROM 512.

The control unit 510 is connected to the network 100 by the communication unit I/F 523. The network 100 is, for example, Wi-Fi.

The communication unit I/F 523 controls transmission and reception of data which are performed via the network 100. For example, the mobile terminal 102 connects to the image forming apparatus 101, the application distribution server 104, the online storage 105, the cloud service server 106, and the IdProvider server 107 via the communication unit I/F 523, thus being able to implement functions using these elements.

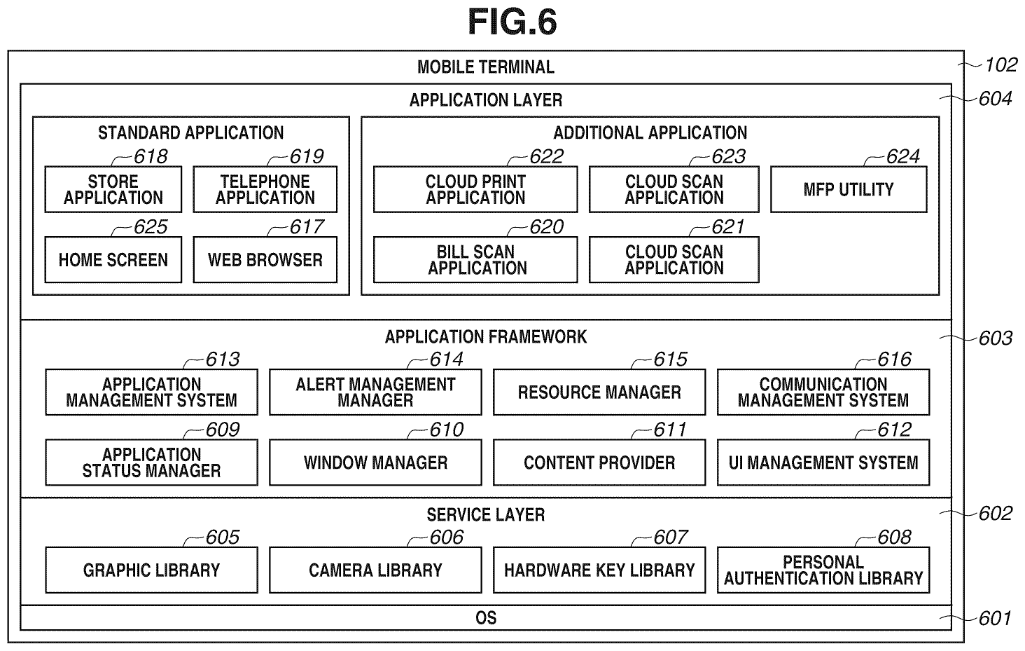

FIG. 6 is a diagram illustrating a software configuration of the mobile terminal 102. While, for explanatory convenience, in FIG. 6, functions for the first exemplary embodiment are mainly illustrated, the functions included in the mobile terminal 102 are not limited to the illustrated functions.

The mobile terminal 102 is configured with an operating system (OS) 601, a service layer 602, an application framework 603, and an application layer 604, and the CPU 511 controls these pieces of software.

The OS 601 is basic software of the mobile terminal 102. Each piece of software on the mobile terminal 102 runs as a process or thread on the OS 601, and the OS 601 provides a library for execution of applications for, for example, communication, operation, and display.

The service layer 602 includes a graphic library 605, which is used to perform two-dimensional (2D) or three-dimensional (3D) displaying using a graphics processing unit (GPU) (not illustrated), and a camera library 606, which is used to control the camera 518. Moreover, the service layer 602 also includes a hardware key library 607, which is used to control hardware keys for, for example, sound volume, and a personal authentication library 608, which is used to control hardware for performing fingerprint authentication or face authentication. The libraries belonging to the service layer 602 are libraries to be used for hardware or software which is not supported by the OS 601.

The application framework 603 provides functions for operations of the applications. An application status manager 609 manages life cycles of the applications. A window manager 610 controls the state of a screen of each application. A content provider 611 manages data which is shared between the applications. A user interface (UI) management system 612 provides components which the applications are able to use with UI constructions, such as buttons and text boxes.

An application management system 613 performs management (for example, installation and uninstallation) of applications retained in the mobile terminal 102. An alert management manager 614 provides, for example, an alert function for providing information about the occurrence of an event. A resource manager 615 performs management of resources such as character strings, graphics, and layouts. A communication management system 616 is used to access a communication function and a telephone function.

The application layer 604 is an application group which runs in the mobile terminal 102, in which there are standard applications and additional applications. The standard applications are applications which are preliminarily installed in factory default on the mobile terminal 102, and include a home screen 625, a web browser 617, a store application 618, and a telephone application 619. The additional applications are applications which are downloaded from the application distribution server 104 and are then stored in the storage 514. In the first exemplary embodiment, the additional applications include a bill scan application 620, a receipt scan application 621, a cloud print application 622, a cloud scan application 623, and an MFP utility 624.

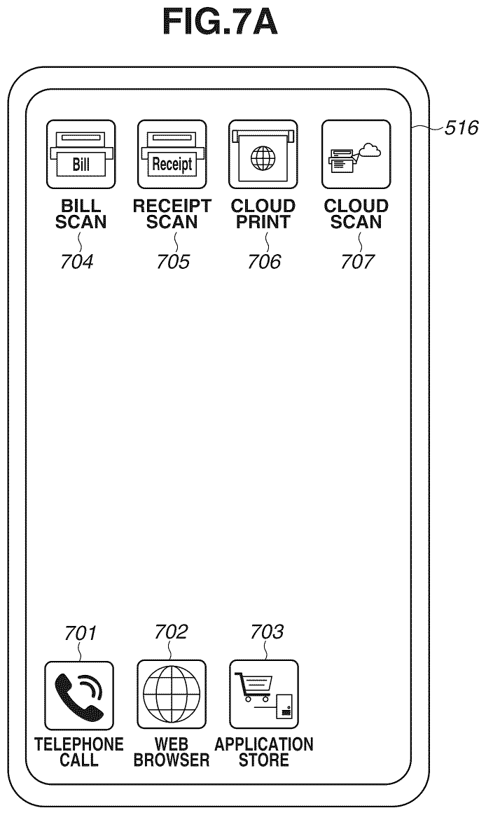

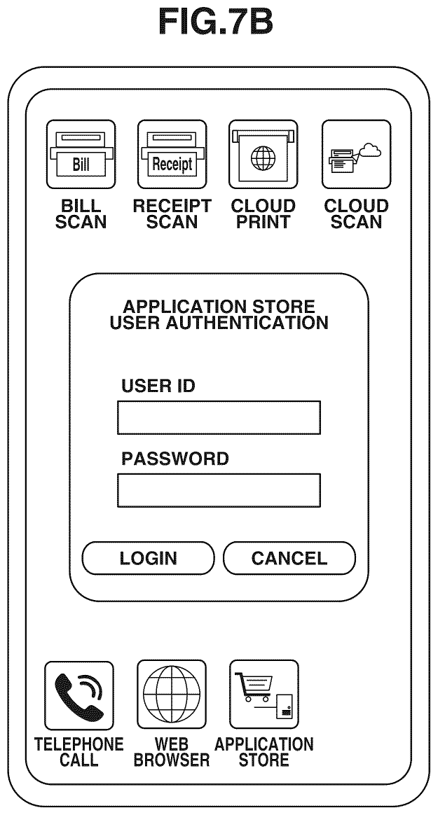

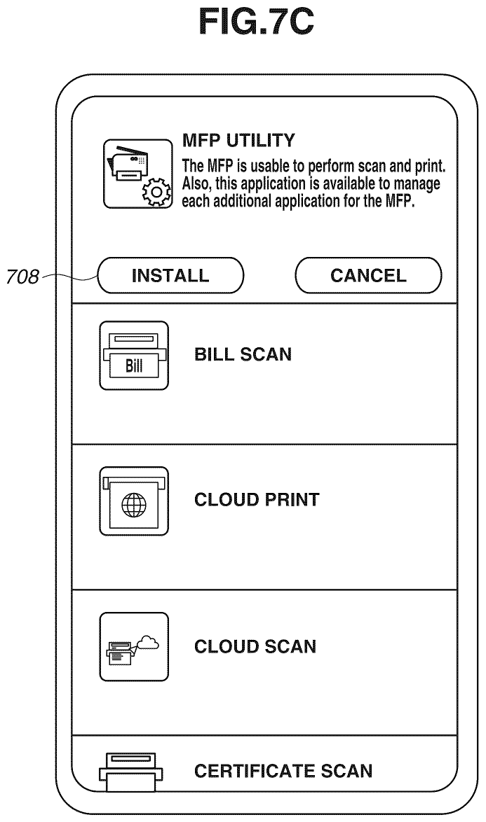

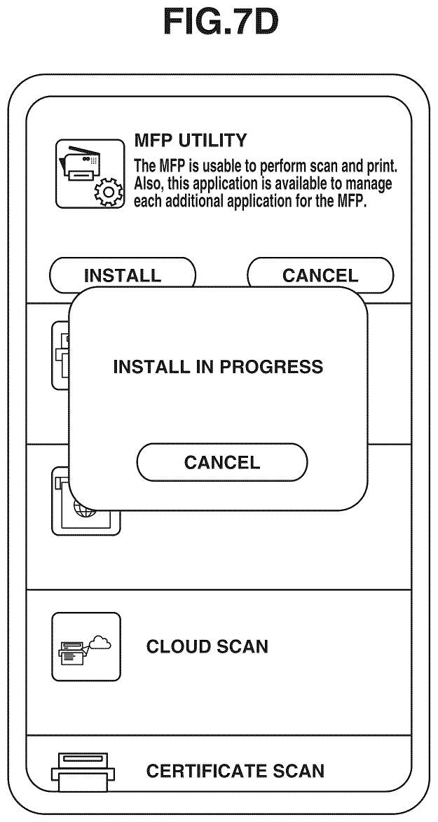

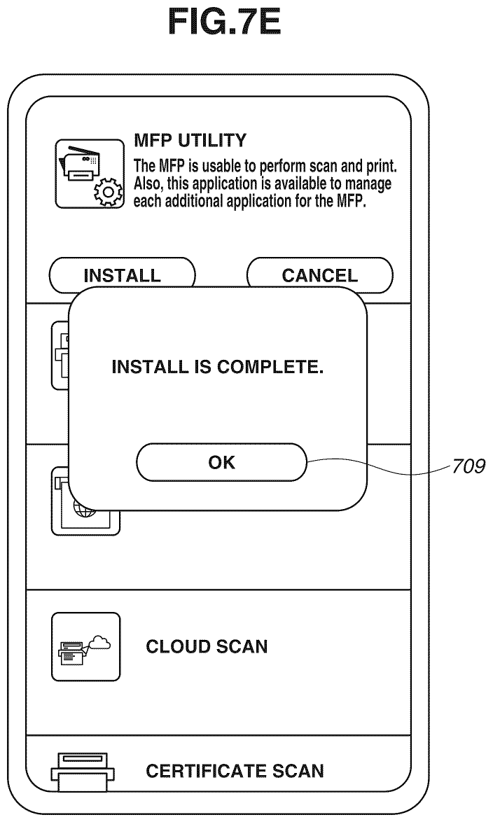

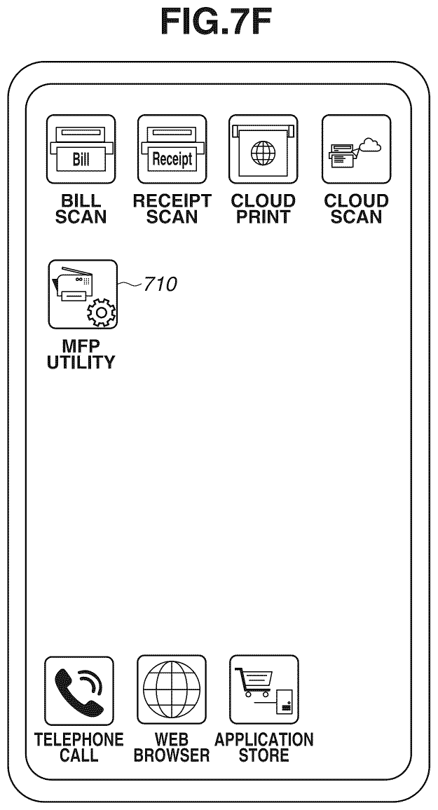

FIG. 7A is a diagram illustrating a home screen which is displayed by the home screen 625, which is one of the standard applications for the mobile terminal 102.

The operation unit 516 of the mobile terminal 102 is configured to be a touch panel, and, in response to the user touching an icon displayed on the touch panel, the CPU 511 of the mobile terminal 102 activates an application corresponding to the touched icon.

As examples of applications to be displayed, the home screen illustrated in FIG. 7A displays icons of respective standard applications, i.e., a telephone call application 701, a web browser 702, and an application store 703. Moreover, the home screen illustrated in FIG. 7A displays icons of respective additional applications, i.e., a bill scan application 704, a receipt scan application 705, a cloud print application 706, and a cloud scan application 707.

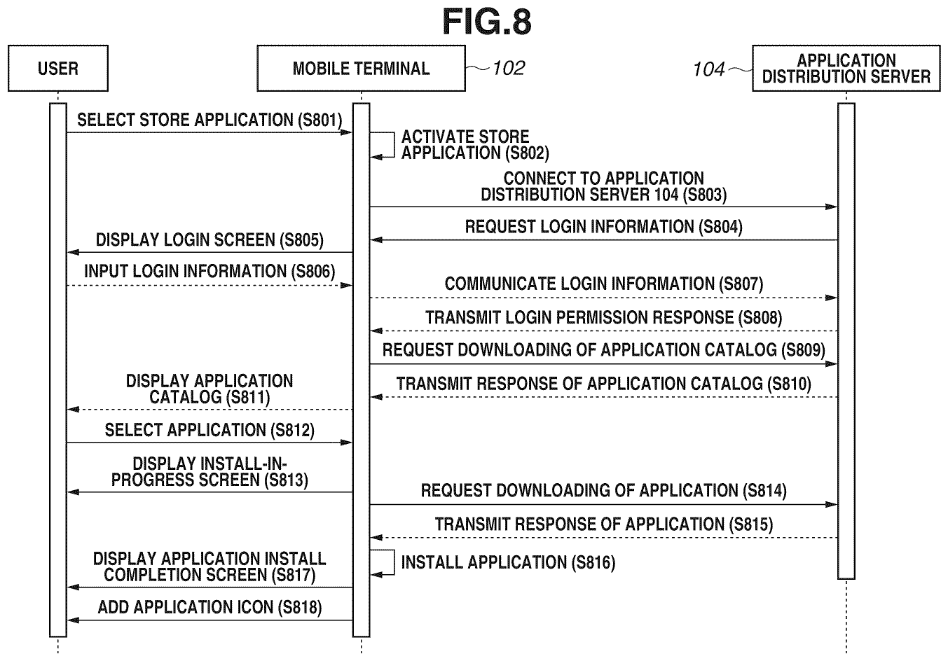

FIG. 8 is a sequence diagram illustrating operations which are performed when the user accesses the application distribution server 104 to install an application on the mobile terminal 102.

In step S801, when the user touches the icon of the application store 703 in the home screen illustrated in FIG. 7A, the coordinates of the pressed portion are communicated from a touch panel controller (not illustrated) to the CPU 511 of the mobile terminal 102. In step S802, based on the communicated coordinates, the CPU 511 of the mobile terminal 102 detects that the icon of the application store 703 has been selected and then activates the store application 618. In step S803, in response to the store application 618 being activated, the CPU 511 of the mobile terminal 102 connects to the application distribution server 104 via the communication unit I/F 523, and, in step S804, the CPU 511 of the mobile terminal 102 is requested by the application distribution server 104 to transmit login information to the application distribution server 104.

Here, in step S805, the CPU 511 of the mobile terminal 102 displays a login screen illustrated in FIG. 7B on the operation unit 516. When, in step S806, the user inputs login information via the operation unit 516, then in step S807, the CPU 511 of the mobile terminal 102 communicates the input login information to the application distribution server 104.

In step S808, the application distribution server 104 communicates a login permission response corresponding to the login information to the mobile terminal 102. In step S809, in the case of succeeding in login, the CPU 511 of the mobile terminal 102 requests the application distribution server 104 to allow downloading of an application catalog, and, in the case of failing in login, the CPU 511 of the mobile terminal 102 returns to displaying of the login screen illustrated in FIG. 7B. In step S810, the application distribution server 104 transmits a response of the application catalog to the mobile terminal 102, and then in step S811, the CPU 511 of the mobile terminal 102 displays an application catalog illustrated in FIG. 7C on the operation unit 516.

In step S812, the user selects, for example, an MFP utility from the application catalog displayed on the operation unit 516, and then touches an install button 708. As a result, in step S813, the CPU 511 of the mobile terminal 102 displays an install-in-progress screen illustrated in FIG. 7D on the operation unit 516. Then, in step S814, the CPU 511 of the mobile terminal 102 requests the application distribution server 104 to allow downloading of the MFP utility.

In step S815, the application distribution server 104 transmits install package data about the requested MFP utility to the mobile terminal 102. The CPU 511 of the mobile terminal 102 stores the downloaded install package in the storage 514 or the RAM 513. Then, in step S816, the CPU 511 of the mobile terminal 102 communicates the install package information to the application management system 613 and performs installation of the MFP utility.

In step S817, upon the completion of installation, the CPU 511 of the mobile terminal 102 displays an install completion screen illustrated in FIG. 7E on the operation unit 516. In step S818, in response to the user touching an OK button 709 in the install completion screen, the CPU 511 of the mobile terminal 102 adds an icon 710 of the MFP utility to the home screen as illustrated in FIG. 7F, and then completes the processing.

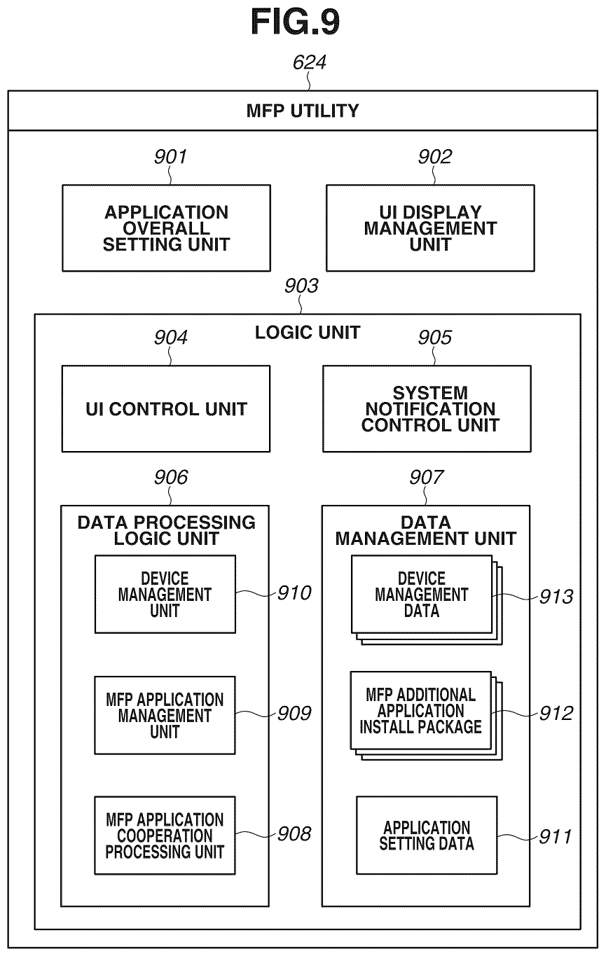

FIG. 9 is a block diagram illustrating a software configuration of the MFP utility 624, which is a mobile terminal application having a management function such as installation and updating of an addition application for the image forming apparatus 101 and also providing functions such as scanning and printing in cooperation with the image forming apparatus 101.

The MFP utility 624 contains (retain inside) at least one install package for an additional application which is executable on the additional application framework 418 of the image forming apparatus 101, and is distributed from the application distribution server 104. Therefore, the user can use the MFP utility 624 to be able to perform installation or updating on the image forming apparatus 101 without the need to separately obtain an install package for an additional application. While, for explanatory convenience, in FIG. 9, functions for the first exemplary embodiment are mainly illustrated, the functions included in the MFP utility 624 are not limited to the illustrated functions.

The MFP utility 624 is configured with an application overall setting unit 901, a UI display management unit 902, and a logic unit 903.

The application overall setting unit 901 assumes the role of system setting which is performed when the MFP utility 624 runs in the mobile terminal 102. For example, the system setting includes an application name, component information about an application, authorization information needed to access, for example, a protective region of the mobile terminal 102, and terminal compatibility information needed by an application.

The UI display management unit 902 performs UI-related data management for, for example, a UI image of an application, layout, and display setting.

The logic unit 903 performs, for example, cooperation with another application and data processing, and is configured with a UI control unit 904, a system notification control unit 905, a data processing logic unit 906, and a data management unit 907.

The UI control unit 904 uses a UI image or display setting of a layout managed by the UI display management unit 902 to perform switching of operation unit displaying according to information received from a user operation, a data processing unit, or a system notification control unit.

The system notification control unit 905 performs processing of a notification received from the OS 601, the service layer 602, or another application of the application layer 604 via the application framework 603 of the mobile terminal 102.

The data processing logic unit 906 performs certain processing in cooperation with the data management unit 907 according to information received from the system notification control unit 905 or the UI control unit 904. The data processing logic unit 906 includes an MFP application cooperation processing unit 908, an MFP application management unit 909, and a device management unit 910.

The data management unit 907 includes application setting data 911, an install package 912 for an additional application which runs on the additional application framework 418 of the image forming apparatus 101, and device management data 913. Then, the data management unit 907 performs management of data which is to be used by applications.

The MFP application cooperation processing unit 908 is a program for performing operations such as scanning and printing in cooperation with an additional application for the image forming apparatus 101. Moreover, the MFP application management unit 909 is a program for performing management of an additional application for the image forming apparatus 101. The MFP application management unit 909 transmits additional application data and an install command to the image forming apparatus 101.

The device management unit 910 performs processing for controlling the communication management system 616 of the mobile terminal 102 to search for a device associated with the MFP utility 624 (in the first exemplary embodiment, the image forming apparatus 101) from on the network 100 and registering the found device as a cooperation device. Furthermore, information about a cooperation device to be registered is assumed to be stored in the device management data 913 while being associated with identification information about the device. Moreover, information about an additional application installed on the image forming apparatus 101 by the MFP application management unit 909 is also stored in the device management data 913 while being associated with the cooperation device information. The application setting data 911 is basic information about the MFP utility 624 and various pieces of operation setting data.

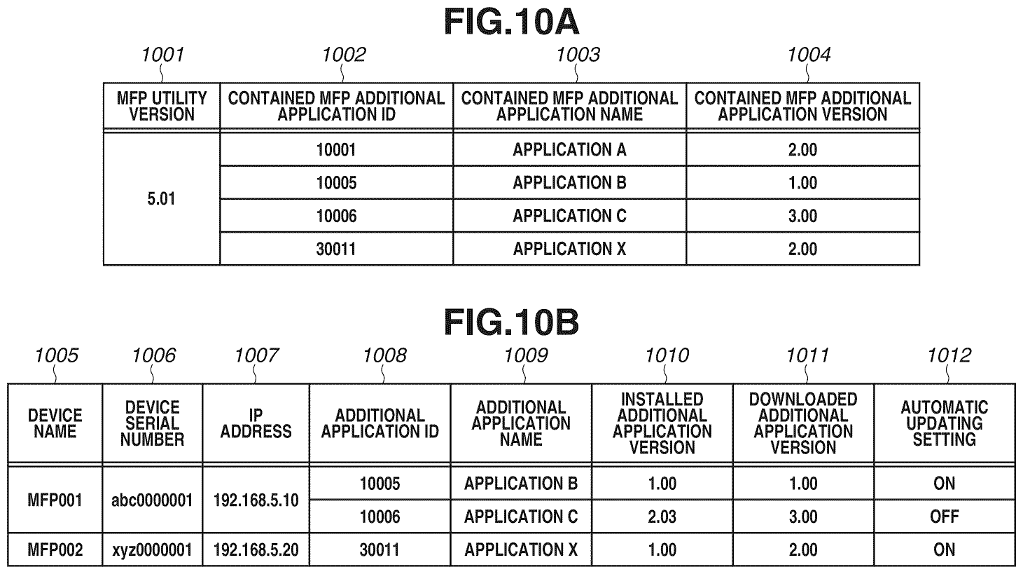

FIGS. 10A and 10B are diagrams respectively illustrating an example of a data structure of basic information about the MFP utility 624, which is stored in the application setting data 911, and an example of a data structure of additional application information for each cooperation device, which is stored in the device management data 913. While, for explanatory convenience, in FIGS. 10A and 10B, pieces of data for the first exemplary embodiment are mainly illustrated, the pieces of data managed with the respective data structures are not limited to the illustrated pieces of data.

FIG. 10A illustrates an example of a data structure of basic information about the MFP utility 624. With the illustrated data structure, respective pieces of information about an MFP utility version 1001, a contained MFP additional application identifier (ID) 1002, a contained MFP additional application name 1003, and a contained MFP additional application version 1004 are managed. Furthermore, the contained MFP additional application ID 1002 and the contained MFP additional application name 1003 are assumed to be unique values for respective additional applications.

FIG. 10B illustrates an example of a data structure of additional application information for each cooperation device. The illustrated data structure is used to manage a device name 1005, device identification information (device serial number) 1006, an Internet Protocol (IP) address 1007, and an additional application ID 1008. Moreover, the illustrated data structure is also used to manage an additional application name 1009, an installed additional application version 1010, a downloaded additional application version 1011, and automatic updating setting 1012. Furthermore, the device identification information 1006 is a device serial number.

Here, the installed additional application version 1010 is version information which is updated when an additional application has been installed on the image forming apparatus 101 with use of the MFP utility 624. Moreover, the downloaded additional application version 1011 is version information about each additional application which the MFP utility 624 contains.

The automatic updating setting 1012 is distributed from the application distribution server 104. The updated content of the MFP utility 624 includes updating of an install package concerning an additional application previously installed on the image forming apparatus 101. Then, the automatic updating setting 1012 is data for setting whether to allow automatic updating of the additional application with respect to the image forming apparatus 101 in a case where a difference has occurred between the installed additional application version 1010 and the downloaded additional application version 1011 concerning the additional application.

In the automatic updating setting 1012, in the initial state thereof, “OFF (automatic updating disabled) is assumed to be set, and the setting value thereof is allowed to be changed by the user's operation (the details thereof being described below).

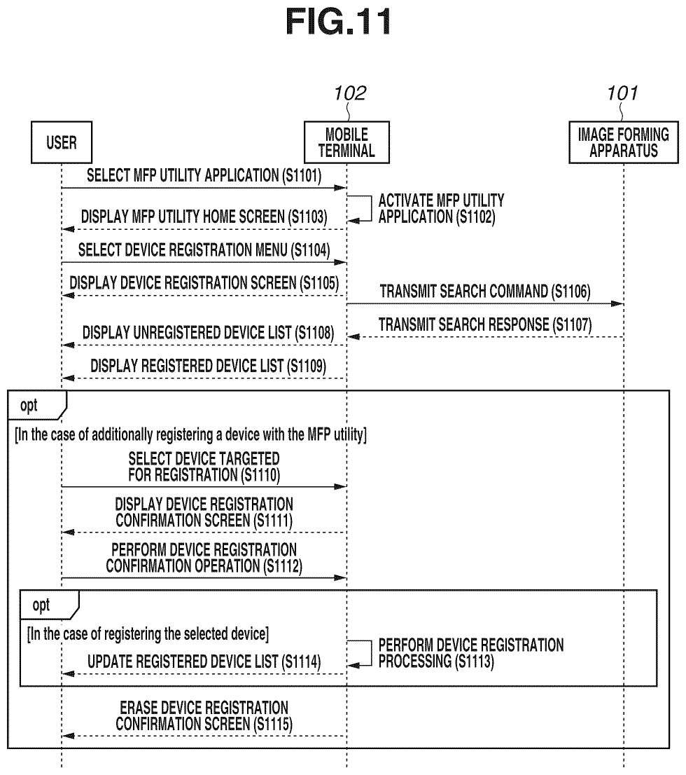

FIG. 11 is a sequence diagram illustrating operations which are performed to register the image forming apparatus 101 as a cooperation device with the MFP utility 624.

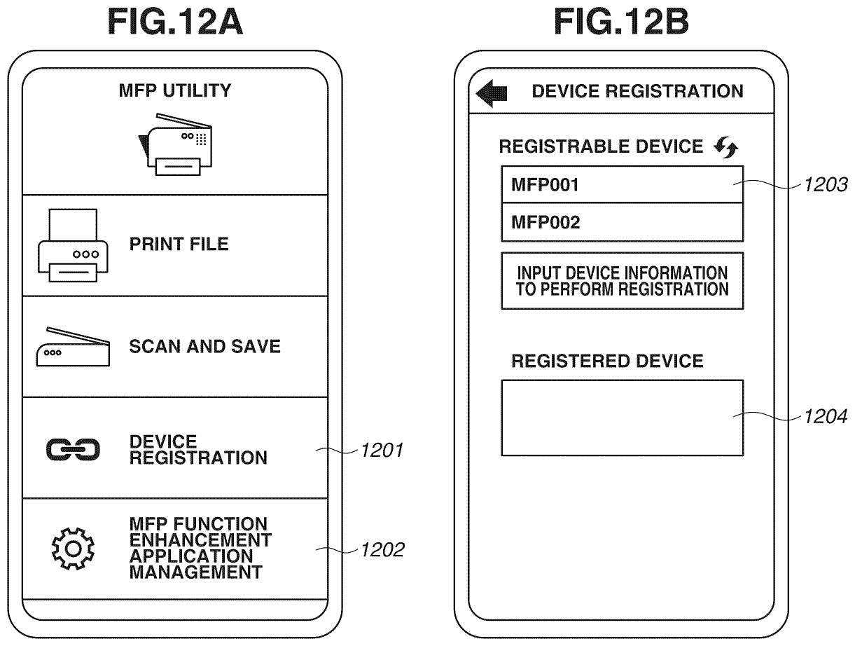

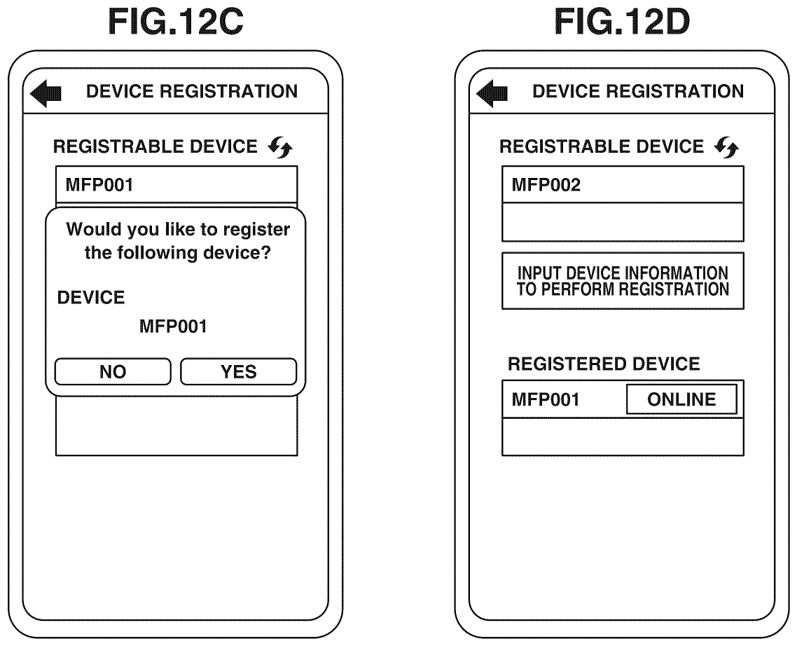

In step S1101, in response to the user touching the MFP utility icon 710 displayed in the home screen illustrated in FIG. 7F, the coordinates of a portion pressed by the user are communicated from a touch panel controller (not illustrated) to the CPU 511 of the mobile terminal 102. Based on the communicated coordinates, the CPU 511 of the mobile terminal 102 detects that the MFP utility icon 710 has been selected. Then, in step S1102, the CPU 511 of the mobile terminal 102 activates the MFP utility 624, and, in step S1103, displays an MFP utility home screen illustrated in FIG. 12A on the operation unit 516.

In step S1104, in response to the user touching a device registration menu 1201 in the MFP utility home screen illustrated in FIG. 12A, then in step S1105, the CPU 511 of the mobile terminal 102 displays a device registration screen illustrated in FIG. 12B on the operation unit 516.

At the same time, in step S1106, the CPU 511 of the mobile terminal 102 executes a program for the device management unit 910, and controls the communication unit I/F 523 via the communication management system 616 to transmit a search command to the image forming apparatus 101 on the network 100. Upon receiving the search command, in step S1107, the image forming apparatus 101 transmits a search response command including identification information and device name of the image forming apparatus 101 to the mobile terminal 102.

When the mobile terminal 102 has received the search response command, the MFP utility 624 compares device identification information obtained from the search response command and registered device information stored in the device management data 913 with each other. Then, the MFP utility 624 creates an unregistered device list and a registered device list.

Then, in step S1108 and step S1109, the MFP utility 624 displays the unregistered device list in a “registrable device” field 1203 illustrated in FIG. 12B and displays the registered device list in a “registered device” field 1204 illustrated in FIG. 12B, respectively. In a case where the image forming apparatus 101 is not currently registered as a cooperation device with the MFP utility 624, in step S1110, the user selects a device name currently displayed in the “registrable device” field 1203 illustrated in FIG. 12B, for example, “MFP001” here. Then, in step S1111, the CPU 511 of the mobile terminal 102 displays a device registration confirmation screen illustrated in FIG. 12C.

Here, if, in step S1112, the user consents to execution of the device registration via the screen operation, then in step S1113, the CPU 511 of the mobile terminal 102 creates management data about the selected device “MFP001” as the device management data 913. Then, in step S1114, the CPU 511 of the mobile terminal 102 updates the content of the registered device list, and, in step S1115, erases the device registration confirmation screen. At that time, the CPU 511 of the mobile terminal 102 also updates the display contents of the “registrable device” field and the “registered device” field on the screen as illustrated in FIG. 12D.

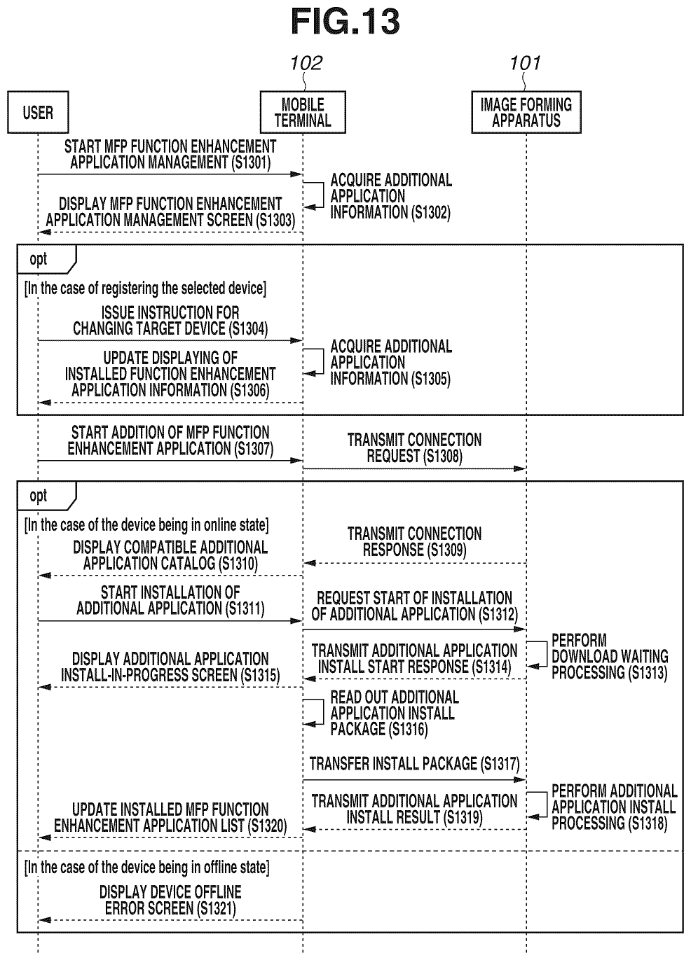

FIG. 13 is a sequence diagram illustrating operations which are performed to install an additional application on the image forming apparatus 101 registered as a cooperation device with the MFP utility 624.

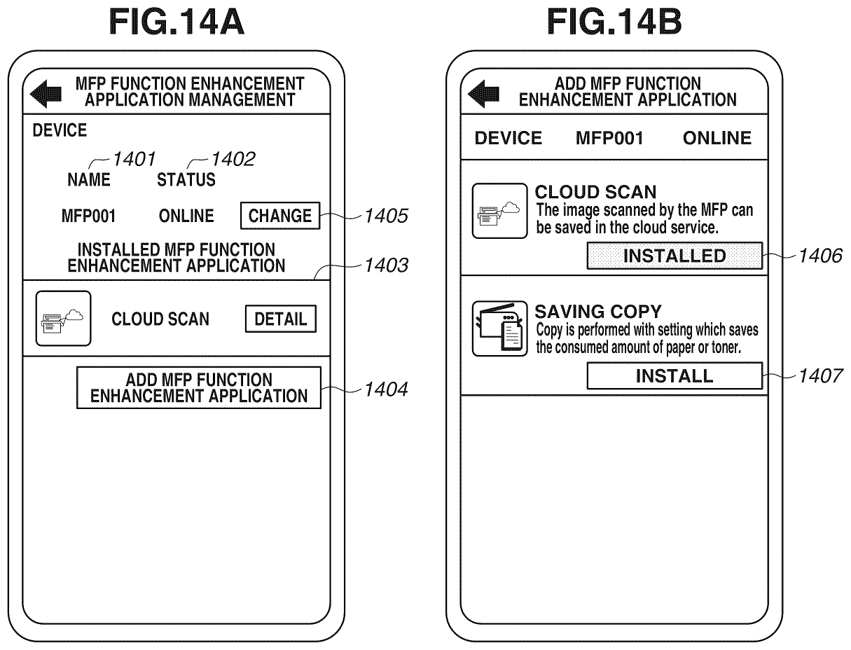

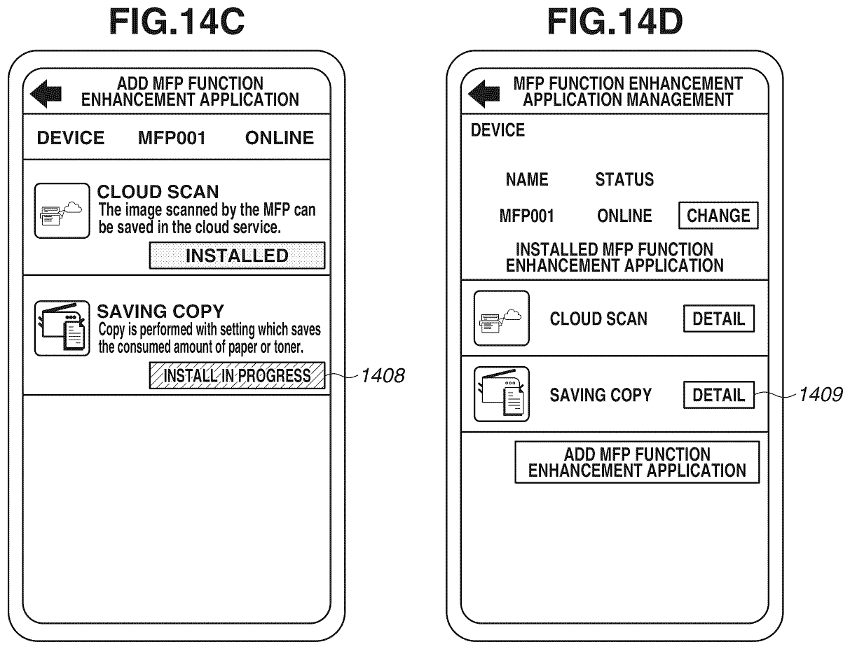

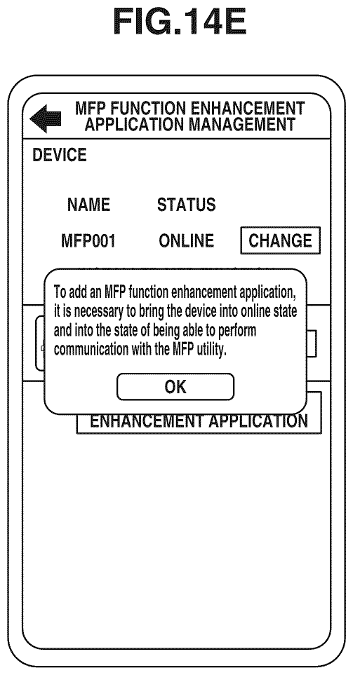

In step S1301, in response to the user touching an MFP function enhancement application management menu 1202 in the MFP utility home screen illustrated in FIG. 12A, the CPU 511 of the mobile terminal 102 determines a device serving as a connection destination based on a past connection history. Then, in step S1302, the CPU 511 of the mobile terminal 102 acquires additional application information for the determined device from the device management data 913, and, in step S1303, displays an MFP function enhancement application management screen illustrated in FIG. 14A on the operation unit 516.

Furthermore, the additional application information is data illustrated in FIG. 10B.

The MFP function enhancement application management screen illustrated in FIG. 14A is used to display a managed object device name 1401, a device status 1402, and an installed MFP function enhancement application list (installed additional application list) 1403.

Here, the managed object device is able to be changed by, in step S1304, the user selecting a change button 1405 and selecting from devices registered in the device management data 913 via a device selection menu (not illustrated). In a case where the managed object device has been changed, in step S1305, the CPU 511 of the mobile terminal 102 acquires additional application information concerning the changed device from the device management data 913. Then, in step S1306, the CPU 511 of the mobile terminal 102 updates the display content of the installed MFP function enhancement application list (installed additional application list) 1403.

In the case of installing an additional application, in step S1307, the user touches an MFP function enhancement application addition button 1404 illustrated in FIG. 14A, thus instructing the mobile terminal 102 to start addition of an additional application. Then, in step S1308, the CPU 511 of the mobile terminal 102 transmits a connection request to the image forming apparatus 101 serving as a managed object device. In step S1309, when being in the state of being able to perform communication (in the online state), the image forming apparatus 101 transmits a connection response to the mobile terminal 102.

In step S1310, upon receiving the connection response from the image forming apparatus 101, the CPU 511 of the mobile terminal 102 displays a catalog screen for additional applications compatible with the image forming apparatus 101 illustrated in FIG. 14B on the operation unit 516.

In the additional application catalog screen illustrated in FIG. 14B, with regard to an additional application the install information about which is currently registered in the device management data 913 concerning the managed object device, a status of “installed” 1406 is displayed. With regard to an additional application the install information about which is not currently registered, an install button 1407 is displayed.

In step S1311, the user touches the install button 1407 for a desired additional application, here, a “saving copy” application, thus issuing an instruction for starting installation of the additional application. Then, in step S1312, the CPU 511 of the mobile terminal 102 transmits an installation start request for the additional application to the image forming apparatus 101.

Upon receiving the installation start request for the additional application, in step S1313, the image forming apparatus (MFP) 101 performs download waiting processing, and, in step S1314, transmits an additional application install start response to the mobile terminal 102. Upon receiving the additional application install start response, the CPU 511 of the mobile terminal 102 disables the install button 1407 concerning the additional application on the operation unit 516 as illustrated in FIG. 14C. Then, in step S1315, the CPU 511 of the mobile terminal 102 displays a status of “install in progress” 1408.

Then, in step S1316, the CPU 511 of the mobile terminal 102 reads out an install package concerning the additional application from the data management unit 907 of the MFP utility 624, and, in step S1317, transfers the install package to the image forming apparatus 101. In step S1318, upon receiving the install package, the image forming apparatus (MFP) 101 performs install processing, and, in step S1319, communicates an install result to the mobile terminal 102.

Upon receiving the install result of the additional application, the mobile terminal 102 updates the installed MFP function enhancement application list (installed additional application list) 1403. Then, in step S1320, the mobile terminal 102 returns displaying from the additional application catalog screen to the MFP function enhancement application management screen as illustrated in FIG. 14D. On the other hand, in a case where there is no response from the image forming apparatus 101 with respect to the connection request transmitted from the mobile terminal 102 in step S1308, then in step S1321, the mobile terminal 102 displays a device offline error screen illustrated in FIG. 14E on the operation unit 516, and then ends the processing. Furthermore, the state in which there is no response means an offline state.

Furthermore, as described above with reference to FIGS. 10A and 10B, it is possible to individually set ON/OFF of automatic updating with respect to respective additional applications installed on the image forming apparatus 101.

In the first exemplary embodiment, an additional application detail screen for the image forming apparatus 101 in the MFP utility 624 is assumed to be used to perform automatic updating setting for the additional application.

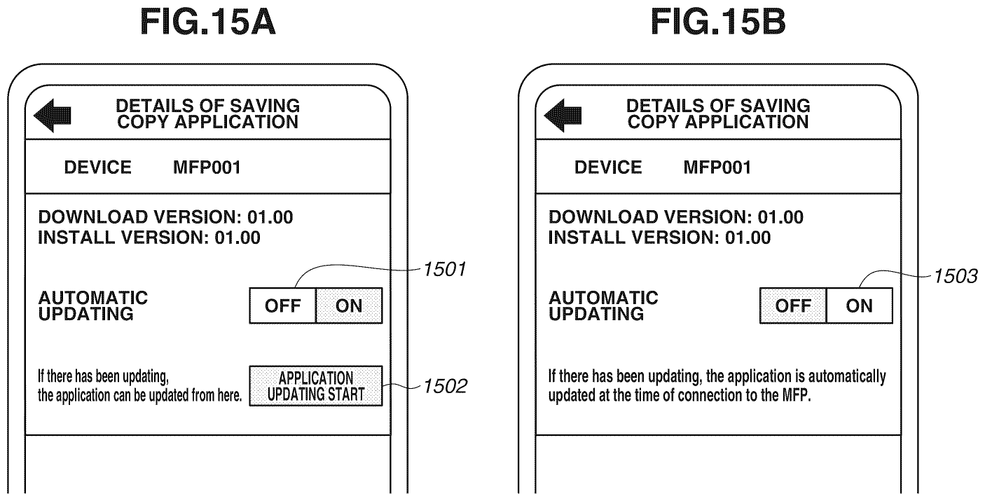

In the MFP function enhancement application management screen illustrated in FIG. 14D, the user selects a detail button for an additional application displayed in the installed MFP function enhancement application list, for example, a detail button 1409 for “saving copy”. Then, the CPU 511 of the mobile terminal 102 displays a detail screen for an additional application illustrated in FIG. 15A or FIG. 15B on the operation unit 516. The detail screen for an additional application is available to check and change the automatic updating setting 1012 of the additional application.

FIG. 15A illustrates a screen which is displayed in a case where the automatic updating setting of the additional application is set to OFF (1501). In a case where there has been updating of the additional application in a state in which the automatic updating setting is OFF, an application updating start button 1502 illustrated in FIG. 15A becomes enabled.

Then, the user issues an instruction for updating start at optional timing, thus being able to perform updating of the additional application for the image forming apparatus 101.

On the other hand, FIG. 15B illustrates a screen which is displayed in a case where the automatic updating setting of the additional application is set to ON (1503). In a case where there has been updating of the additional application in a state in which the automatic updating setting is ON, if the user activates the MFP utility 624 and connects the mobile terminal 102 to the image forming apparatus 101, updating processing is automatically started.

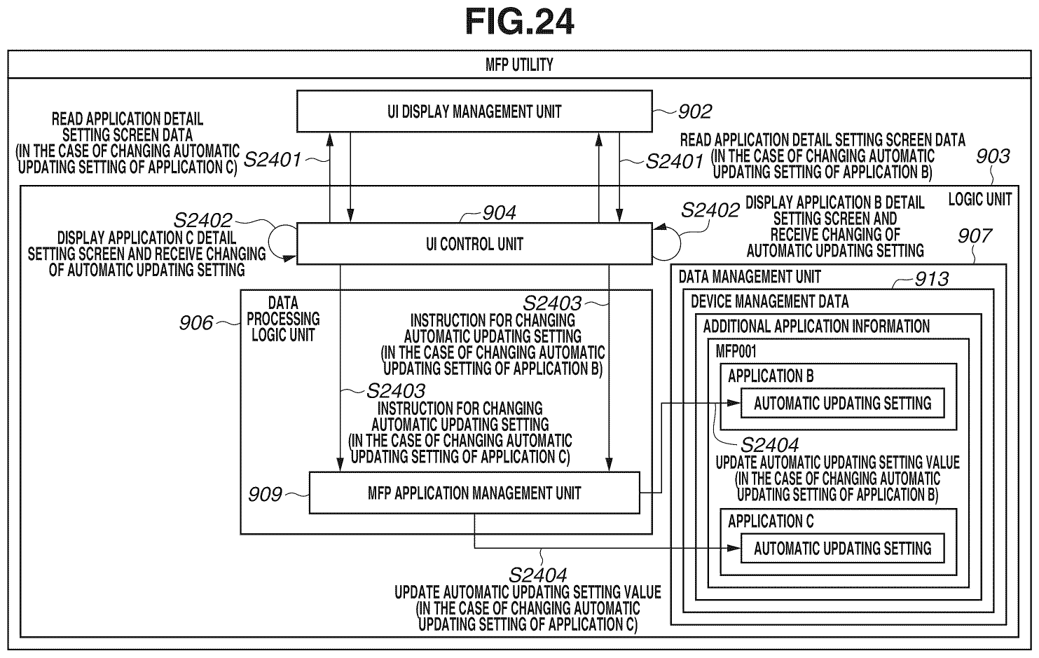

FIG. 24 is a diagram illustrating, with use of related blocks of the MFP utility 624, control flows which are executed to perform automatic updating setting for individual additional applications for the image forming apparatus 101.

First, in the MFP function enhancement application management screen illustrated in FIG. 14D, the user selects a detail button for a desired additional application, for example, the detail button 1409 for “saving copy”. Next, in step S2401, the UI control unit 904 reads detail setting screen data about the additional application from the UI display management unit 902, and, in step S2402, displays a detail setting screen (illustrated in FIG. 15A or FIG. 15B) for the additional application on the operation unit 516. Then, the UI control unit 904 receives an automatic updating setting change operation from the user.

Here, when the user changes the automatic updating setting (operates the button 1501 illustrated in FIG. 15A or the button 1503 illustrated in FIG. 15B), then in step S2403, the UI control unit 904 instructs the MFP application management unit 909 to change the automatic updating setting concerning the additional application. In step S2404, upon receiving an instruction for changing the automatic updating setting, the MFP application management unit 909 updates an automatic updating setting value stored in the additional application information concerning the image forming apparatus 101 retained in the device management data 913 included in the data management unit 907, into a changed value.

Furthermore, here, the image forming apparatus 101 is, for example, “MFP001”, and the additional application information is expressed as information about an application B.

Furthermore, automatic updating setting concerning another additional application (for example, an application C) for the image forming apparatus 101 is also able to be changed with a control flow similar to the control flow described above with reference to FIG. 24. In that case, the target to be handled in step S2401 to step S2404 illustrated in FIG. 24 is replaced by the application C, and an automatic updating setting value for additional application information for the application C to be stored in the device management data 913 is updated.

Thus, with the procedure described above with reference to FIGS. 14A to 14E, FIGS. 15A and 15B, and FIG. 24, it is possible to individually set ON/OFF of automatic updating with respect to each additional application installed on the image forming apparatus 101.

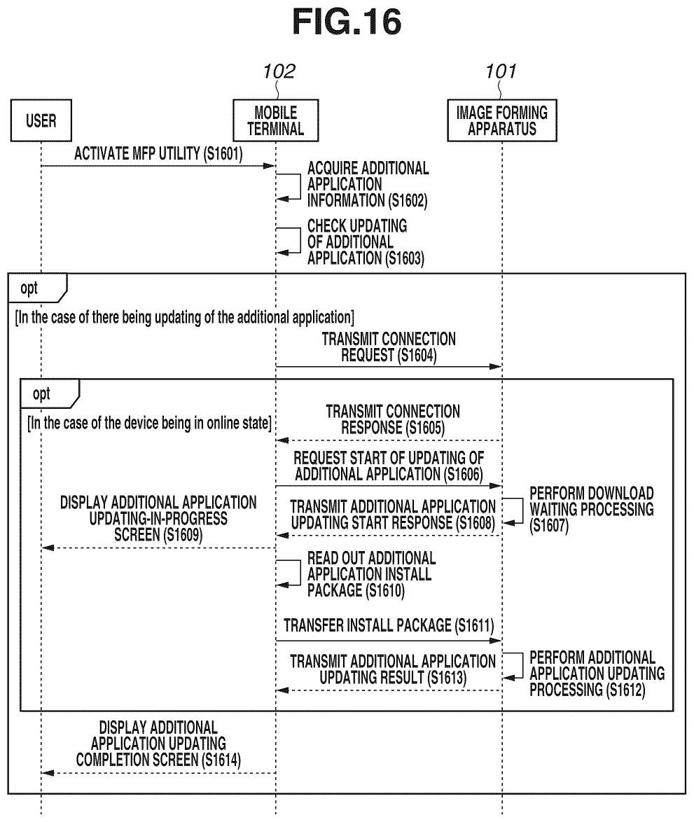

FIG. 16 is a sequence diagram illustrating operations which are performed to automatically update an additional application for the image forming apparatus 101 registered as a cooperation device with the MFP utility 624.

First, in step S1601, the user touches the MFP utility icon 710 displayed in the home screen illustrated in FIG. 7F, and thus activates the MFP utility 624. Next, in step S1602, the CPU 511 of the mobile terminal 102 acquires basic information about the MFP utility 624 stored in the application setting data 911 and additional application information about a registered cooperation device stored in the device management data 913.

Furthermore, the above-mentioned basic information is data illustrated in FIG. 10A, and the above-mentioned additional application information is data illustrated in FIG. 10B.

Then, in step S1603, the CPU 511 of the mobile terminal 102 checks the cooperation device for the presence or absence of updating concerning an installed additional application. Specifically, based on the additional application information acquired in step S1602, the CPU 511 of the mobile terminal 102 checks whether the automatic updating setting is ON and there is a device having an updatable additional application introduced therein. Here, the CPU 511 of the mobile terminal 102 is assumed to, if the downloaded additional application version 1011 is newer than the installed additional application version 1010, determine that the additional application is updatable. Here, in a case where there is updating concerning the additional application, automatic updating processing expressed by a sequence including step S1604 to step S1614 is started.

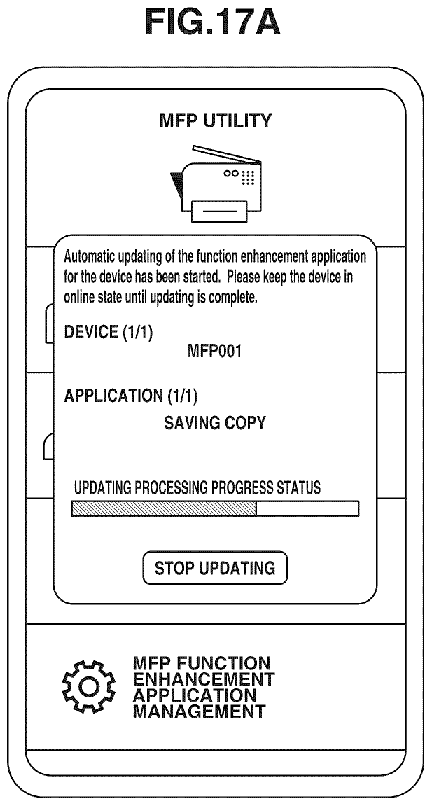

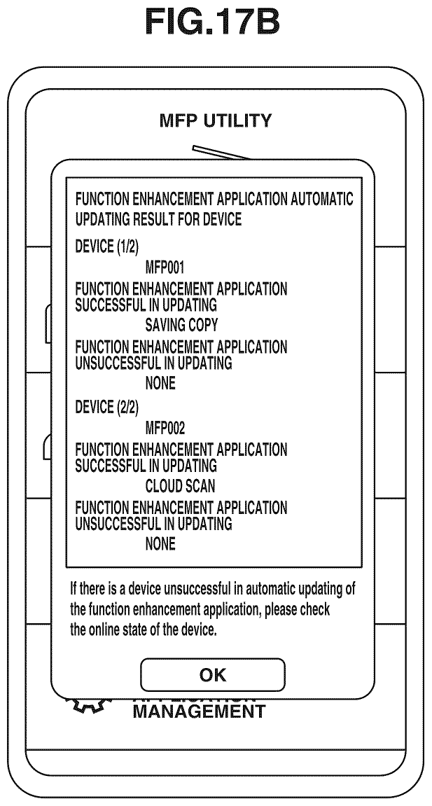

First, in step S1604, the CPU 511 of the mobile terminal 102 transmits a connection request to a device targeted for updating of the additional application (here, the image forming apparatus 101 being used for description as a representative example). In step S1605, when being in the state of being able to perform communication (in the online state), the image forming apparatus 101 transmits a connection response as a reply to the mobile terminal 102. In step S1606, upon receiving the connection response from the image forming apparatus 101, the CPU 511 of the mobile terminal 102 transmits an additional application updating start request to the image forming apparatus 101. Upon receiving the additional application updating start request, in step S1607, the image forming apparatus (MFP) 101 performs download waiting processing, and, in step S1608, transmits an additional application updating start response as a reply to the mobile terminal 102. In step S1609, upon receiving the additional application updating start response, the CPU 511 of the mobile terminal 102 displays an additional application updating-in-progress screen illustrated in FIG. 17A on the operation unit 516.

Then, in step S1610, the CPU 511 of the mobile terminal 102 reads out the MFP additional application install package 912 concerning the additional application targeted for updating from the data management unit 907 of the MFP utility 624. Then, in step S1611, the CPU 511 of the mobile terminal 102 transfers the install package 912 to the image forming apparatus 101.

Upon receiving the install package 912, in step S1612, the image forming apparatus 101 performs updating processing of the additional application, and, in step S1613, communicates an updating result to the mobile terminal 102. In step S1614, upon receiving the updating result of the additional application, the mobile terminal 102 displays an automatic updating result screen illustrated in FIG. 17B on the operation unit 516.

On the other hand, in a case where there is no response from the image forming apparatus 101 with respect to the connection request transmitted from the mobile terminal 102 in step S1604 (when the image forming apparatus 101 is in the offline state), the mobile terminal 102 displays information indicating that updating of the additional application concerning the applicable device is unsuccessful in the automatic updating result screen illustrated in FIG. 17B.

Furthermore, in the first exemplary embodiment, the CPU 511 of the mobile terminal 102 checks the cooperation device for the presence or absence of updating concerning an installed additional application at the time of activating the MFP utility 624. Then, if there is updating, automatic updating of the additional application is started. For example, while performing a background operation on the mobile terminal 102, the MFP utility 624 establishes connection with the image forming apparatus 101. As a result, if it is determined that automatic updating is able to be started, a notification display to the user is performed on the mobile terminal 102. Then, automatic updating can be configured to be started based on another timing, for example, automatic updating is started in response to the user consenting in the notification screen.

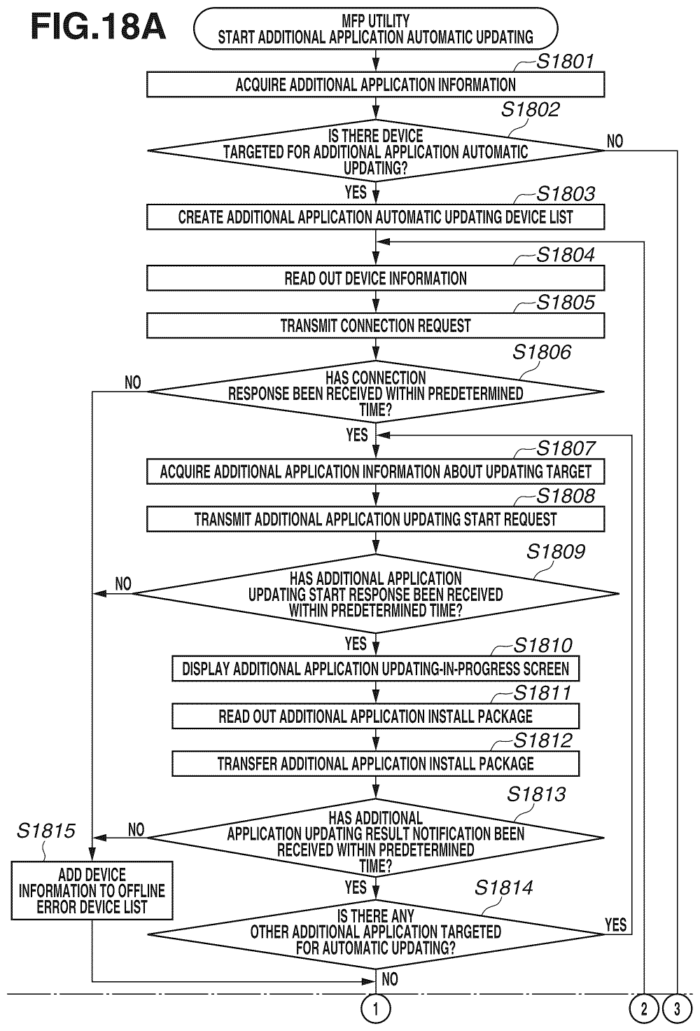

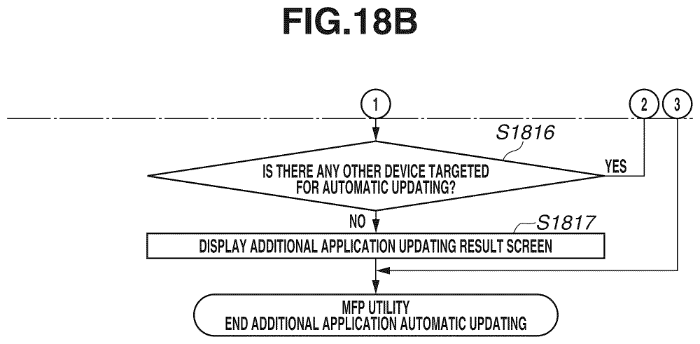

FIGS. 18A and 18B are flowcharts used to explain automatic updating processing concerning an additional application for a cooperation device, which is performed by the MFP utility 624. Steps illustrated in FIGS. 18A and 18B are assumed to be executed by the CPU 511 of the mobile terminal 102, unless otherwise described.

First, in step S1801, the CPU 511 of the mobile terminal 102 acquires additional application information (data illustrated in FIG. 10B) about a registered cooperation device from the device management data 913. Next, in step S1802, the CPU 511 of the mobile terminal 102 checks whether there is a device in which automatic updating setting is ON and an updatable additional application is previously introduced, based on the additional application information acquired in step S1801. Here, the CPU 511 of the mobile terminal 102 is assumed to, if the downloaded additional application version 1011 is newer than the installed additional application version 1010, determine that the additional application is updatable.

Here, if it is determined that the applicable device exists (YES in step S1802), the CPU 511 of the mobile terminal 102 advances the processing to step S1803, and, if not so (NO in step S1802), the CPU 511 of the mobile terminal 102 ends the automatic updating processing. In step S1803, the CPU 511 of the mobile terminal 102 creates a list of devices on which automatic updating of an additional application is to be performed. In step S1804, the CPU 511 of the mobile terminal 102 reads out device information from the device list created in step S1803, and, in step S1805, transmits a connection request to a device identified based on the device information. In step S1806, the CPU 511 of the mobile terminal 102 checks whether a connection response has been received from the device within a predetermined time.

Here, if it is determined that the connection response has been received within the predetermined time (YES in step S1806), the CPU 511 of the mobile terminal 102 advances the processing to step S1807, and, if not so (NO in step S1806), the CPU 511 of the mobile terminal 102 advances the processing to step S1815. In step S1807, the CPU 511 of the mobile terminal 102 acquires additional application information about a target for updating from the additional application information acquired in step S1801.

In step S1808, the CPU 511 of the mobile terminal 102 transmits an updating start request for an additional application to the device serving as a connection destination. In step S1809, the CPU 511 of the mobile terminal 102 checks whether an additional application updating start response has been received from the device within a predetermined time. Here, if it is determined that the additional application updating start response has been received within the predetermined time (YES in step S1809), the CPU 511 of the mobile terminal 102 advances the processing to step S1810, and, if not so (NO in step S1809), the CPU 511 of the mobile terminal 102 advances the processing to step S1815. In step S1810, the CPU 511 of the mobile terminal 102 displays the additional application updating-in-progress screen (illustrated in FIG. 17A). In step S1811, the CPU 511 of the mobile terminal 102 reads out the install package 912 concerning an additional application targeted for updating from the data management unit 907. In step S1812, the CPU 511 of the mobile terminal 102 transfers an install package for the additional application to the device serving as a connection destination.

In step S1813, the CPU 511 of the mobile terminal 102 checks whether an additional application updating result notification has been received from the device within a predetermined time. Here, if it is determined that the additional application updating result notification has been received within the predetermined time (YES in step S1813), the CPU 511 of the mobile terminal 102 advances the processing to step S1814, and, if not so (NO in step S1813), the CPU 511 of the mobile terminal 102 advances the processing to step S1815.

In step S1814, the CPU 511 of the mobile terminal 102 checks whether there is another additional application targeted for automatic updating concerning the currently connected device. Here, if it is determined that there is another additional application targeted for automatic updating (YES in step S1814), the CPU 511 of the mobile terminal 102 returns the processing to step S1807, and then repeats processing operations in step S1807 to step S1815 with respect to the currently connected device. If not so (NO in step S1814), the CPU 511 of the mobile terminal 102 advances the processing to step S1816. In step S1815, the CPU 511 of the mobile terminal 102 stores device information about the connection destination in an offline error device list, and then advances the processing to step S1816. In step S1816, the CPU 511 of the mobile terminal 102 checks whether there is another device on which automatic updating of an additional application is to be performed, based on the device list created in step S1803.

Here, if it is determined that there is another device on which automatic updating is to be performed (YES in step S1816), the CPU 511 of the mobile terminal 102 returns the processing to step S1804, and then repeats processing operations in step S1804 to step S1816 with respect to the target device.

If not so (NO in step S1816), the CPU 511 of the mobile terminal 102 advances the processing to step S1817 to display an additional application updating result screen (illustrated in FIG. 17B), and then ends a series of operations for the automatic updating processing.

Here, in the additional application updating result screen illustrated in FIG. 17B, an updating result of an additional application concerning each device for which there has been updating of the additional application is displayed. Moreover, with respect to a device which is unsuccessful in updating of an additional application, a message prompting the user to check the online state of the device (the state of connection to the MFP utility 624) is also displayed.

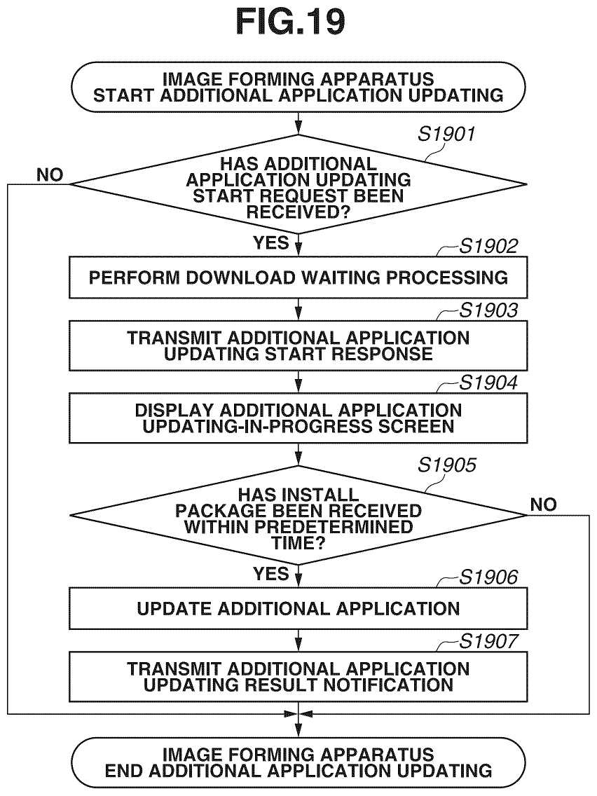

FIG. 19 is a flowchart used to explain update processing for an additional application, which is performed by the image forming apparatus 101 in response to an instruction from the MFP utility 624. Steps illustrated in FIG. 19 are assumed to be executed by the CPU 211 of the image forming apparatus 101, unless otherwise described.

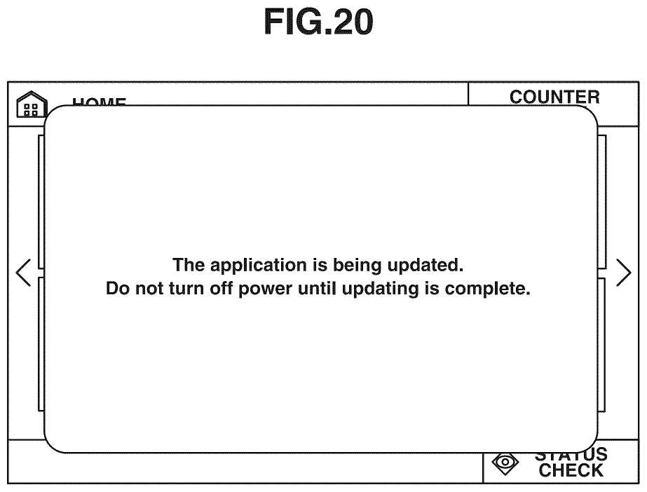

First, in step S1901, the CPU 211 of the image forming apparatus 101 checks the presence or absence of reception of an additional application updating start request from the mobile terminal 102. If it is determined that the additional application updating start request has not been received (NO in step S1901), the CPU 211 of the image forming apparatus 101 ends the processing. If it is determined that the additional application updating start request has been received (YES in step S1901), then in step S1902, the CPU 211 of the image forming apparatus 101 performs download waiting processing concerning an install package for an additional application. Specifically, the CPU 211 of the image forming apparatus 101 controls the communication unit I/F 223 via the communication unit manager 407 and thus performs reception waiting of an install package which is transmitted via the network 100. In step S1903, the CPU 211 of the image forming apparatus 101 transmits an additional application updating start response to the mobile terminal 102. In step S1904, the CPU 211 of the image forming apparatus 101 displays an additional application updating-in-progress screen illustrated in FIG. 20 on the operation unit 216, thus blocking a user operation using the operation unit 216.

In step S1905, the CPU 211 of the image forming apparatus 101 checks whether the reception of install package data for the additional application has been completed within a predetermined time. Here, if it is determined that the reception of install package data has been completed within the predetermined time (YES in step S1905), the CPU 211 of the image forming apparatus 101 advances the processing to step S1906, and, if not so (NO in step S1905), the CPU 211 of the image forming apparatus 101 ends the processing. In step S1906, the CPU 211 of the image forming apparatus 101 unpacks the received install package data and causes the additional application management manager 419 and the data management manager 410 to perform updating of the additional application program. Upon the completion of updating of the additional application, in step S1907, the CPU 211 of the image forming apparatus 101 transmits an additional application updating result notification to the mobile terminal 102, and then ends a series of operations for the processing.

In the above-mentioned way, in a system which uses the MFP utility 624 to perform installation and updating of an additional application for the image forming apparatus 101, the MFP utility 624 is provided with automatic updating setting for an additional application for the image forming apparatus 101. Then, the automatic updating setting value is managed in association with the status of installation on the image forming apparatus 101.

Furthermore, the MFP utility 624 runs on the mobile terminal 102.

Additionally, with regard to an additional application for which automatic updating setting is enabled (ON), whether updating concerning the additional application is included in the updating content of the MFP utility 624 distributed from the application distribution server 104 is checked. Then, if updating concerning the additional application is included, when the MFP utility 624 and the image forming apparatus 101 are connected to each other next time, updating processing of the additional application is automatically performed.

On the other hand, with regard to an additional application for which automatic updating setting is disabled (OFF), updating of the additional application is configured not to be performed until an instruction from the user is received.

In the above-mentioned way, for example, an application having an application property which is complete in the image forming apparatus 101 has no relations (has weak relations) with, for example, a system outside of the image forming apparatus 101. Accordingly, a trouble is unlikely to occur in the operation of the image forming apparatus 101 due to updating of the application.

On the other hand, an application having an application property which is not complete in the image forming apparatus 101 has relations (has strong relations) with, for example, a system outside of the image forming apparatus 101. Accordingly, if the application for the image forming apparatus 101 is updated without consideration of, for example, the consistency with the system outside of the image forming apparatus 101, a trouble is likely to occur in the operation of the image forming apparatus 101 due to updating of the application.

In the first exemplary embodiment, with regard to updating of applications having such various application properties, for example, in a case where an application has no relations with a system outside of the image forming apparatus 101, the application can be set to automatic updating. Moreover, in a case where an application has relations with a system outside of the image forming apparatus 101, the user can manually perform updating of the application in conformity with updating of the outside system.

As described above, according to the first exemplary embodiment, since the user is allowed to individually set an application to automatic updating, it is possible to reduce the probability of occurrence of various troubles caused by application properties of applications. Moreover, it is possible to decrease a cumbersome operation to be performed by the user.

Furthermore, the above-mentioned user can be a user of a terminal device, a user of an information processing apparatus, or a maintenance personnel who maintains or manages such device or apparatus.

In the first exemplary embodiment, automatic updating setting for an additional application for which the initial value for setting whether to perform automatic updating is OFF (disabled/automatic updating not being set) has been changed by the user operating the MFP utility 624. As a result, automatic updating of an additional application for which automatic updating is set to ON (enabled/automatic updating being set) has been described.

On the other hand, in a second exemplary embodiment of the present disclosure, a recommended setting value for automatic updating setting concerning each additional application is distributed from the application distribution server 104 in combination with the MFP utility 624. Then, when the additional application is installed on the image forming apparatus 101, the recommended setting value is applied as an initial value for automatic updating setting for the additional application, as described below with reference to the following configuration.

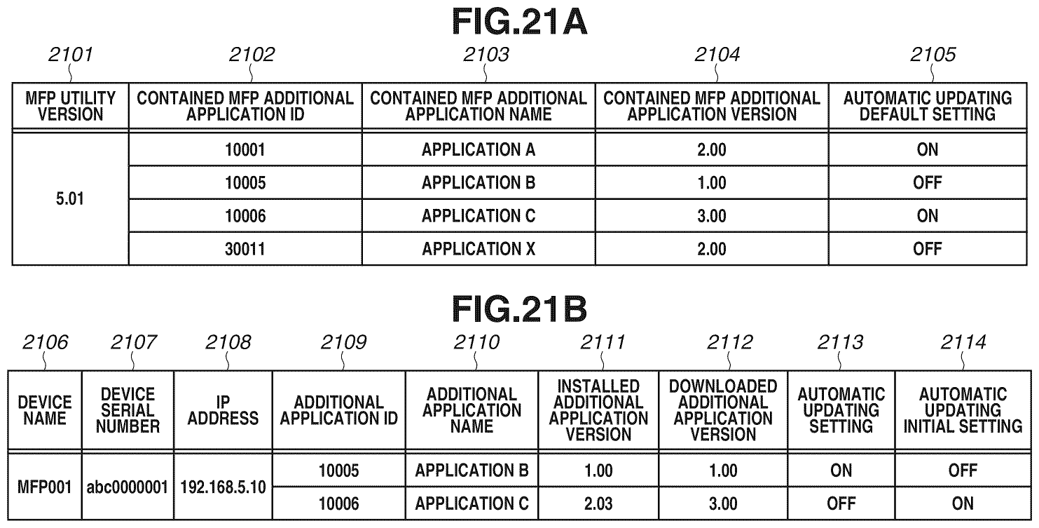

FIG. 21A illustrates a data structure of basic information about the MFP utility 624 in the second exemplary embodiment. The illustrated data structure is used to manage an MFP utility version 2101, a contained MFP additional application identifier (ID) 2102, a contained MFP additional application name 2103, and a contained MFP additional application version 2104, and is also used to manage automatic updating default setting 2105.

Furthermore, the MFP utility version 2101, the contained MFP additional application ID 2102, the contained MFP additional application name 2103, and the contained MFP additional application version 2104 are the same in data type as those 1001 to 1004 described in the first exemplary embodiment.

The automatic updating default setting 2105 is a recommended value for automatic updating setting concerning each additional application, and, in the second exemplary embodiment, is assumed to be data which is distributed from the application distribution server 104 in the form of being contained in the MFP utility 624. However, the automatic updating default setting 2105 can be configured to be distributed as data separated from the MFP utility 624.

FIG. 21B illustrates a data structure of additional application information for each cooperation device in the second exemplary embodiment. The illustrated data structure is used to manage a device name 2106, device identification information 2107, an Internet Protocol (IP) address 2108, an additional application ID 2109, and an additional application name 2110. Moreover, the illustrated data structure is also used to manage an application version 2111, an application version 2112, and automatic updating setting 2113. Additionally, the illustrated data structure is also used to manage automatic updating initial setting 2114.

The device name 2106, the device identification information 2107, the IP address 2108, the additional application ID 2109, the additional application name 2110, the application version 2111, and the application version 2112 are the same in data type as those 1005 to 1011 described in the first exemplary embodiment. Moreover, the automatic updating setting 2113 is the same in data type as the automatic updating setting 1012 described in the first exemplary embodiment. Additionally, the device identification information 2107 is a device serial number. Additionally, the application version 2111 is an installed additional application version, and the application version 2112 is a downloaded additional application version.

The automatic updating initial setting 2114 is a value obtained by duplicating a setting value for the automatic updating default setting 2105 concerning each additional application, described above with reference to FIG. 21A, and such duplicated setting value is assumed to be unable to be changed by the user. In the first exemplary embodiment described above, with regard to the automatic updating setting 1012 illustrated in FIG. 10B, OFF (automatic updating being disabled) is set in the initial state. In the second exemplary embodiment, in the initial state immediately after each additional application is installed on the image forming apparatus 101, the automatic updating setting 2113 illustrated in FIG. 21B is a value obtained by duplicating a setting value for the automatic updating initial setting 2114. Moreover, as with the first exemplary embodiment, the automatic updating setting 2113 illustrated in FIG. 21B allows the setting value to be changed by the user's operation.

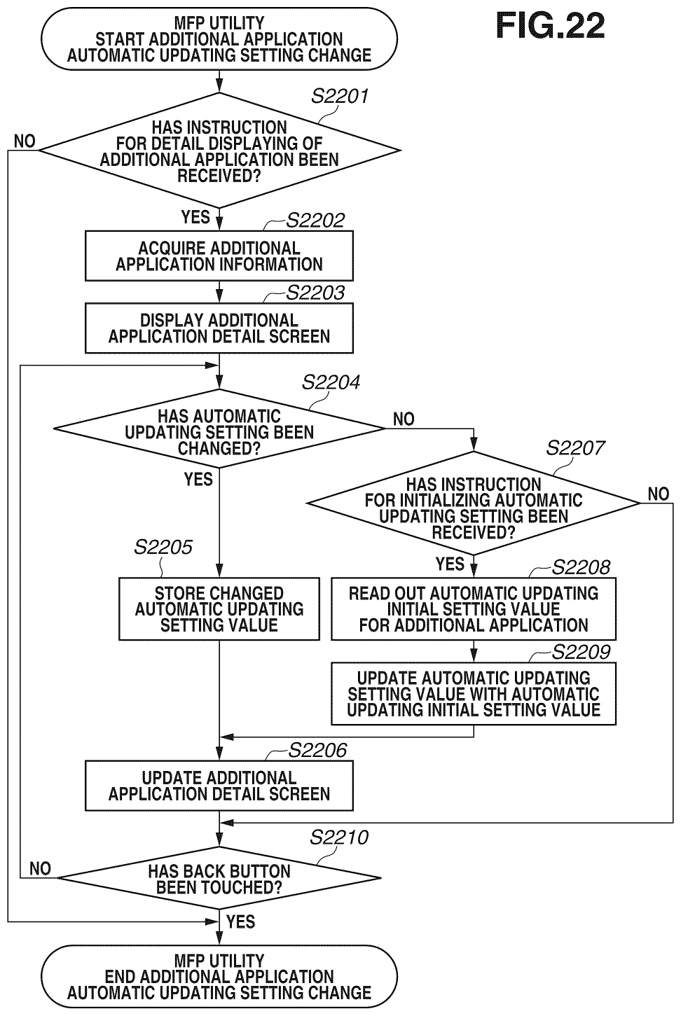

FIG. 22 is a flowchart used to explain processing which is performed by the MFP utility 624 to change automatic updating setting concerning an additional application for the cooperation device in the second exemplary embodiment. Steps illustrated in FIG. 22 are assumed to be executed by the CPU 511 of the mobile terminal 102, unless otherwise described.

First, in step S2201, the CPU 511 of the mobile terminal 102 checks whether a detail button for an additional application which is displayed in the installed MFP function enhancement application field has been selected by the user. Here, if it is determined that the detail button for an additional application has been selected (YES in step S2201), the CPU 511 of the mobile terminal 102 advances the processing to step S2202, and, if not so (NO in step S2201), the CPU 511 of the mobile terminal 102 ends the processing.

Furthermore, the MFP function enhancement application management screen has been explained with use of FIG. 14A or FIG. 14D.

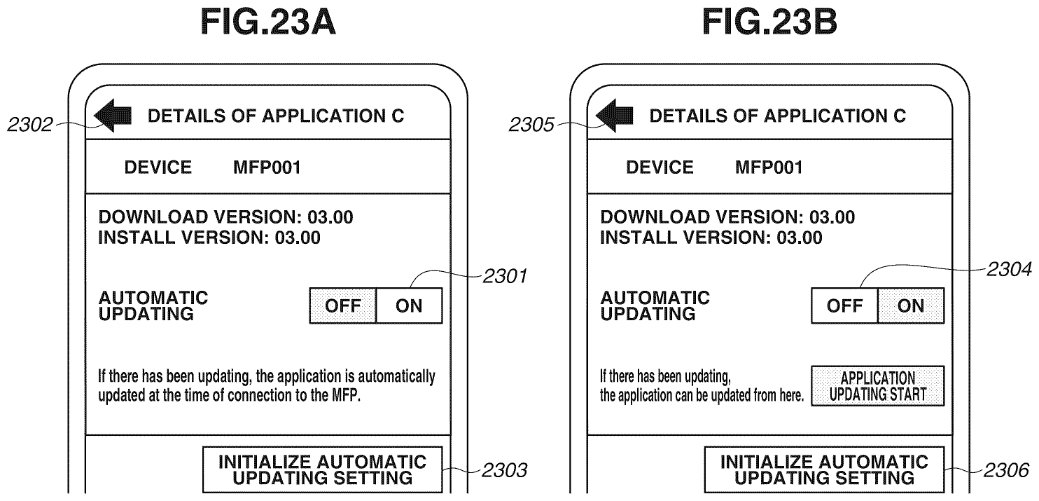

In step S2202, the CPU 511 of the mobile terminal 102 reads out the device management data 913 from the data management unit 907 and thus acquires additional application information concerning the applicable device. In step S2203, the CPU 511 of the mobile terminal 102 displays a detail screen for an additional application illustrated in FIG. 23A or FIG. 23B on the operation unit 516. FIG. 23A illustrates a screen which is displayed in a case where automatic updating setting for the additional application is currently set to ON (2301), and FIG. 23B illustrates a screen which is displayed in a case where automatic updating setting for the additional application is currently set to OFF (2304).

In step S2204, the CPU 511 of the mobile terminal 102 checks whether automatic updating setting has been changed in the detail screen for an additional application. Here, if it is determined that automatic updating setting has been changed (YES in step S2204), the CPU 511 of the mobile terminal 102 advances the processing to step S2205, and, if not so (NO in step S2204), the CPU 511 of the mobile terminal 102 advances the processing to step S2207. In step S2205, the CPU 511 of the mobile terminal 102 stores the changed automatic updating setting value in the device management data 913. In step S2206, the CPU 511 of the mobile terminal 102 updates the display content of the detail screen for an additional application according to the changed automatic updating setting.

In step S2207, the CPU 511 of the mobile terminal 102 checks whether an initialization button for automatic updating setting (a button 2303 illustrated in FIG. 23A or a button 2306 illustrated in FIG. 23B) has been selected in the detail screen for an additional application. Here, if it is determined that initialization of automatic updating setting has been selected (YES in step S2207), the CPU 511 of the mobile terminal 102 advances the processing to step S2208, and, if not so (NO in step S2207), the CPU 511 of the mobile terminal 102 advances the processing to step S2210. In step S2208, the CPU 511 of the mobile terminal 102 reads out automatic updating initial setting (2114 illustrated in FIG. 21B) for the additional application from the additional application information. In step S2209, the CPU 511 of the mobile terminal 102 updates the automatic updating setting value (2113 illustrated in FIG. 21B) for the additional application with the automatic updating initial setting value read out in step S2208.

In step S2210, the CPU 511 of the mobile terminal 102 checks whether a back button (2302 illustrated in FIG. 23A or 2305 illustrated in FIG. 23B) has been selected in the detail screen for an additional application. Here, if it is determined that the back button has been selected (YES in step S2210), the CPU 511 of the mobile terminal 102 ends the processing, and, if not so (NO in step S2210), the CPU 511 of the mobile terminal 102 returns the processing to step S2204 and then repeats processing operations in step S2204 to step S2209.

Furthermore, the method of using the MFP utility 624 of the mobile terminal 102 to perform installation and updating of an addition application for the image forming apparatus 101 is similar to that in the first exemplary embodiment. Accordingly, the description of installation and updating of an additional application is omitted.

As described above, in the second exemplary embodiment, a recommended setting value of automatic updating setting concerning each additional application for the image forming apparatus 101 is distributed in combination with the MFP utility 624 from the application distribution server 104. Then, when an additional application has been installed on the image forming apparatus 101, the recommended setting value is applied as an initial value of automatic updating setting of the additional application.

In this way, a default value of automatic updating is able to be distributed and provided according to application properties which differ with respective applications in provision source of an additional application.

As described above, according to the second exemplary embodiment, in addition to the advantageous effect of the first exemplary embodiment being obtained, the user is enabled to operate an image forming apparatus, a terminal device, and an information processing system without having difficulty in determining automatic updating setting.

Furthermore, while, in the second exemplary embodiment, an information processing system configured with an image forming apparatus and a terminal device has been described, the second exemplary embodiment can be applied to a configuration including only an image forming apparatus.

For example, an information processing apparatus can be configured to include a setting unit capable of individually performing automatic updating setting with respect to an application which runs in the information processing apparatus. Moreover, an information processing apparatus can be configured to include a setting unit capable of individually performing automatic updating setting based on information received from outside of the information processing apparatus.

In this way, as long as an information processing apparatus itself includes the setting unit, in the first exemplary embodiment or the second exemplary embodiment, the advantageous effect of not needing to include a terminal device is produced.

Moreover, the above-mentioned setting unit capable of individually performing automatic updating setting with respect to an application can be located anywhere in an information processing system including an information processing apparatus, and a setting apparatus including the setting unit can be contained in the information processing system as an apparatus separate from other apparatuses.

Additionally, as compared with an application an initial value of automatic updating setting of which is OFF, an application an initial value of automatic updating setting of which is ON has a high probability of playing an important role for an information processing apparatus in which the application runs. Moreover, an initial value of automatic updating setting of an application is often set by a side which provides the application (for example, a manufacturer) or a knowledgeable person about the application, such as an administrator of an information processing apparatus, a terminal device, or an information processing system. Therefore, as long as the setting of an initial value of automatic updating setting is ON, even if the application is automatically updated, the probability of a trouble occurring in the information processing apparatus is low.

Accordingly, as compared with an application an initial value of automatic updating setting of which is OFF but is then changed to ON by the user, an application an initial value of automatic updating setting of which is ON has a low probability of a trouble occurring in the information processing apparatus due to automatic updating.

From the above reason, it is desirable to automatically update an application an initial value of automatic updating setting of which is ON, in preference to an application an initial value of automatic updating setting of which is OFF but is then changed to ON.

Moreover, it is highly likely that, as compared with an application the frequency of use of which is low when the user uses an information processing apparatus, an application the frequency of use of which is high is an important application for the user.

Accordingly, in applications in which the automatic updating setting is ON, it is desirable to automatically update an application the frequency of use of which is high in preference to an application the frequency of use of which is low.

Additionally, in a case where there is a plurality of applications an initial value of automatic updating setting of each of which is OFF but is then changed to ON, it is favorable to take into consideration the sequential order in time series at the time when the initial value of automatic updating setting is changed to ON. Specifically, it is highly likely that a preceding application the automatic updating setting has been set to ON is a more important application than a following application the automatic updating setting has been set to ON. Moreover, it is favorable to take into consideration the timing in time series at the time when the user has changed the automatic updating setting to ON. For example, the timing when the automatic updating setting has been changed from OFF to ON is, for example, the time when the user has turned on power for the first time after purchasing an information processing apparatus or the time when the user has turned on and off power about several times (for example, within ten times) after turning on power for the first time. It is highly likely that an application the automatic updating setting of which has been changed from OFF to ON at such timing is also an important application for the user.

In the above-described way, it is desirable to automatically update an application which is estimated to be important in preference to an application which is estimated to be relatively unimportant.

Furthermore, while, in the above description, operations which are performed after the user has purchased an information processing apparatus have been described, operations which are performed in a case where the user has used an information processing apparatus for the first time can be considered to be performed in a manner similar to that described above.

Moreover, in the first exemplary embodiment, a configuration in which the user individually selects an application from a catalog of applications and the mobile terminal 102 individually downloads and installs an application from the application distribution server 104 has been described. Here, an initial value of automatic updating setting in the second exemplary embodiment can be used for the catalog.

Specifically, in the catalog of applications, each application an initial value of automatic updating setting of which is ON is not displayed, and only each application an initial value of automatic updating setting of which is OFF is displayed.

Then, employing a configuration in which, with respect to an application an initial value of automatic updating setting of which is OFF, the user determines whether to change the automatic updating to ON, thus selecting ON or OFF of the automatic updating setting, enables providing a catalog which is simpler and easier to operate for the user.

Moreover, a configuration in which the user is able to readily discriminate, on the catalog, between an application an initial value of automatic updating setting of which is ON and an application an initial value of automatic updating setting of which is OFF can be employed, so that the user can recognize that there is an application an initial value of automatic updating setting of which is ON.

For example, depending on initial values of automatic updating setting, the size, shape, or color (including grayout) of, for example, character, pattern, or icon representing an application on the catalog can be varied. Moreover, depending on initial values of automatic updating setting, a selection sound produced when an application has been selected on the screen can be varied, or, in the case of the screen being a touch panel display, a vibration or contact sensation which is transmitted to the user at the time of screen touch can be varied.

Additionally, an initial value of automatic updating setting can be expressed in a set with an application on the catalog. Moreover, a combination of these can be expressed. In this way, a configuration in which, in a catalog of applications, various expressions, including a hiding configuration, are used to enable the user to smoothly discriminate and change an initial value of automatic updating setting can be employed.

Moreover, an initial value of automatic updating setting can be individually provided or can be collectively provided for each application. Moreover, an initial value of automatic updating can be individually acquired or can be collectively acquired from outside of a terminal device or an information processing apparatus. Moreover, an initial value of automatic updating setting can be located anywhere, such as in a terminal device, an information processing apparatus, or an apparatus different from these devices or apparatuses, and an updating unit only needs to be able to be acquired.

The present disclosure can also be implemented by processing for supplying a program for implementing one or more functions of the above-described exemplary embodiments to a system or apparatus via a network or a storage medium and causing one or more processors included in a computer of the system or apparatus to read out and execute the program. Moreover, the present disclosure can also be implemented by a circuit which implements one or more functions of the above-described exemplary embodiments (for example, an application specific integrated circuit (ASIC)).

The present disclosure is not limited to the above-described exemplary embodiments, and can be altered or modified in various manners without departing from the scope of the present disclosure.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-187632 filed Nov. 1, 2023, which is hereby incorporated by reference herein in its entirety.

What is claimed is:

1. A terminal device connectable to an information processing apparatus, the terminal device comprising: at least one memory storing instructions;
at least one processor that, upon execution of the stored instructions is configured to operate as:
a setting unit configured to set, for each respective application software running on the information apparatus that the terminal device is connected to, whether to individually perform automatic updating for the respective piece of application software.

2. The terminal device according to claim 1, wherein the terminal device includes an initial value of the setting as to whether to perform automatic updating.

3. The terminal device according to claim 2, wherein the terminal device acquires the initial value from a device different from the terminal device.

4. The terminal device according to claim 1, wherein the terminal device acquires, via network, at least one piece of application software from a device different from the terminal device.

5. The terminal device according to claim 1, wherein, in the terminal device, the setting as to whether to perform automatic updating includes a setting for individually performing automatic updating or a setting for not performing automatic updating with respect to each piece of application software which runs in the information processing apparatus.

6. The terminal device according to claim 1, wherein, in the terminal device, the setting as to whether to perform automatic updating includes, in a mixed manner, a setting for performing automatic updating or a setting for not performing automatic updating.

7. The terminal device according to claim 1, wherein, in the terminal device, the setting to perform automatic updating includes frequency of use component such that automatic updating is performed when respective ones of each piece of application software have a higher frequency of use than others of each piece of application software that have a lower frequency of use.

8. The terminal device according to claim 2, wherein, in the terminal device, in a case where the setting of the automatic updating regarding a piece of application software set by the setting unit is changed to perform automatic update, the update for the piece of application software will occur after updating other application software that has been initially set to update.

9. The terminal device according to claim 2, wherein, in the terminal device, the setting as to whether to perform automatic updating includes, in the each piece of application software in which an initial value of the setting as to whether to perform automatic updating is a setting for not performing automatic updating and the setting as to whether to perform automatic updating has been changed to a setting for performing automatic updating, updating the each piece of application software in which the setting as to whether to perform automatic updating has been changed to a setting for performing automatic updating in advance in time series in preference to the each piece of application software in which the setting as to whether to perform automatic updating has been changed to a setting for performing automatic updating later.

10. An information processing apparatus comprising:
a setting unit configured to allow performing a setting as to whether to individually perform automatic updating with respect to each piece of application software which runs in the information processing apparatus.

11. The information processing apparatus according to claim 10, wherein the information processing apparatus comprises a setting unit configured to allow performing a setting as to whether to individually perform automatic updating based on information received from outside of the information processing apparatus.

12. An information processing system comprising an information processing apparatus and a terminal device different from the information processing apparatus,
wherein the terminal device comprises a setting unit configured to allow performing a setting as to whether to individually perform automatic updating with respect to each piece of application software which runs in the information processing apparatus.

13. The information processing system according to claim 12, wherein the terminal device includes an initial value of the setting as to whether to perform automatic updating.

14. The information processing system according to claim 13, wherein the terminal device acquires the initial value from a device different from the terminal device.

15. The information processing system according to claim 12, wherein the terminal device acquires the each piece of application software from a device different from the terminal device.

16. The information processing system according to claim 13, further comprising an application distribution server,
wherein the terminal device acquires the each piece of application software or the initial value from the application distribution server.

17. A method of, in a terminal device connectable to an information processing apparatus, performing a setting as to whether to perform automatic updating of each piece of application software which runs in the information processing apparatus, the method comprising:
performing a setting as to whether to individually perform automatic updating with respect to each piece of application software which runs in the information processing apparatus; and
transmitting a result of the setting as to whether to perform automatic updating to the information processing apparatus.
